(19) United States
(12) Patent Application Publication
(10) Pub. No.: US 2026/0065022 A1
(43) Pub. Date: Mar. 5, 2026

(54) LANGUAGE DETECTION AND LANGUAGE TRANSLATION EVALUATION FOR LLMS USING RAIOPS INTEGRATED LLMOPS METRICS

(71) Applicant: Accenture Global Solutions Limited, Dublin (IE)

(72) Inventors: Kamakshi SUBRAMANIAM, Rochester, MI (US); Atish Shankar Ray, Herndon, VA (US)

(21) Appl. No.: 18/820,025

(22) Filed: Aug. 29, 2024

(51) Int. Cl. G06N 3/0455

(52) U.S. Cl. CPC G06N 3/0455

(57) ABSTRACT

Method, system, and computer-readable storage media for improving a language detection task and a language translation task of a Large Language model (LLM) are disclosed. In response to receiving data associated with a prompt, chunks are generated. Each of the chunks includes a subset of the data. A language of each chunk is identified using language detection libraries. A translation output is generated in a preferred target translation language using the LLM. The translation output is evaluated using metrics, each of the metrics evaluates the translation output for one or more translation quality aspects. A score value is generated for each numerical metric of the metrics. Further, a SAFE score value is generated, based upon the score value for each numerical metric of the metrics. Based on the SAFE score value meeting a predetermined threshold, the translation output is transmitted or presented.

### TECHNICAL FIELD

Various examples described herein relate generally to computer-implemented method, computer system, and computer program product for improving language detection tasks and evaluation of language translation tasks for Large Language Models (LLMs) using Responsible Artificial Intelligence Operations (RAIOPS) integrated Large Language Model Operations (LLMOPS) metrics.

### BACKGROUND

Generative Artificial Intelligence (Gen AI) refers to advanced AI systems that emulate human cognitive abilities across various applications. The advanced AI systems use sophisticated methods to autonomously process complex data, make decisions, and solve problems. Further, Gen AI encompasses a broad category of AI systems, including specialized subsets like Large Language Models (LLMs) designed for Natural Language Processing (NLP) tasks. The LLMs are trained to understand and generate human-like responses based on input prompts. The LLMs excel in tasks such as language translation, text summarization, sentiment analysis, contextual understanding, and the like.

### SUMMARY

Implementations of the present disclosure are generally directed to improving language detection tasks and evaluation of language translation tasks of Large Language Models (LLMs). More particularly, implementations of the present disclosure are directed to evaluation of performance of the LLMs in the language translation tasks by assessing translation accuracy and quality through various metrics and a SAFE score, thereby determining whether the LLM needs optimization or tuning to improve its performance.

In at least one example, the present disclosure provides a computer-implemented method for improving a language detection task and a language translation task of a Large Language Model (LLM). The computer-implemented method may include generating, in response to receiving data associated with a prompt, a plurality of chunks. Each chunk of the plurality of chunks may include a subset of the data. The computer-implemented method may further include identifying a language of each chunk, using a plurality of language detection libraries. The computer-implemented method may further include generating a translation output using the LLM in a preferred target translation language. The computer-implemented method may include evaluating the translation output using a plurality of metrics. Each metric of the plurality of metrics may evaluate the translation output for one or more translation quality aspects. The computer-implemented method may further include generating a score value for each numerical metric of the plurality of metrics. The computer-implemented method may further include generating, based upon the score value for each numerical metric of the plurality of metrics, a SAFE score value. The computer-implemented method may further include causing, based upon the SAFE score value that meets a predetermined threshold condition, the translation output to be transmitted or presented.

The present disclosure further describes a system for implementing the method provided herein. The present disclosure also describes computer-readable media coupled to one or more processors and having instructions stored thereon which, when executed by the one or more processors, cause the one or more processors to perform operations in accordance with the method described herein.

It is appreciated that methods in accordance with the present disclosure may include any combination of the aspects and features described herein. That is, the method in accordance with the present disclosure is not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various examples in accordance with the present disclosure will be described with reference to the drawings, in which:

FIG. 1 illustrates an example architecture of a language detection and translation system, in accordance with implementations of the present disclosure.

FIG. 2 illustrates an example architecture including a Generative Artificial Intelligence (Gen AI) integration and evaluation engine of the present disclosure.

FIG. 3 depicts an example block diagram of the language detector and translator in the Gen AI integration and evaluation engine for language detection and translation tasks, in accordance with implementations of the present disclosure.

FIG. 4 depicts an example process flow of language detection and evaluation of language translation using Responsible AI Operations (RAIOPS) integrated Large Language Model Operations (LLMOPS) metrics, in accordance with implementations of the present disclosure.

FIG. 5 is a flow diagram that presents an example computer-implemented method for improving a language detection task and a language translation task of a LLM, in accordance with implementations of the present disclosure.

FIG. 6 illustrates a computer system that may be used to implement the language detection and translation system of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example”, “an example of”, by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope of the invention as set forth in the claims.

With the advent of Generative Artificial Intelligence (Gen AI) systems, enterprises are adopting the Gen AI systems to support execution of various tasks/processes. For example, a Gen AI system may support communications and interactions, and processes in software systems to support decision-making within the enterprises. Multiple applications within a corporate network environment may use and interact with Large Language Models (LLMs) of the Gen AI systems to provide input and/or data for the execution of a wide variety of tasks, such as, human computer interactions (i.e., questioning/querying and answering), automating process execution, process planning, generating step-by-step procedures for the process execution, performing data analysis, and/or the like. The LLMs operate by processing inputs to generate coherent, and contextually appropriate responses.

Further, language detection and translation tasks are critical components in the functionality of the LLMs within the Gen AI systems. The language detection and translation tasks enable effective communication across diverse linguistic contexts. The LLMs identify languages of input text, allowing the input text to process and interpret information from a wide range of linguistic backgrounds. The capability of identifying the languages of the input text is complemented by translation functions, which facilitate seamless communication and data exchange by converting the text between different languages. Together, these features (e.g., language detection and translation) support a broad spectrum of applications.

Despite the potential of language identification and translation of the LLMs, enterprises face significant challenges in ensuring that the LLMs perform language translation with high accuracy, maintain linguistic fairness, and handle a diverse range of languages and contexts effectively. The complexity and variability inherent in natural languages, coupled with limitations of known language detection and translation frameworks, often lead to inconsistent performance, particularly in the presence of synonyms, idiomatic expressions, and multilingual content.

The currently known language detection and translation frameworks often rely on traditional statistical measures and models, which fail to fully address nuances of multilingual and multi-contextual language processing. Further, the limitations in the known language detection and translation include inherent linguistic diversity, and contextual variations. For example, languages with complex grammar and diverse vocabularies pose significant hurdles for accurate translation. Further, the known language detection and translation frameworks may have the following limitations:

Ambiguity in language detection: The known language detection and translation frameworks may find difficulty in accurately determining the language of a text when faced with multiple languages or ambiguous linguistic cues.

Inconsistent translation quality: The known language detection and translation framework may provide variation in translation quality and metrics across different languages and text types that impacts reliability on the LLMs.

Translation evaluation challenges: Problems in evaluating translation quality effectively, with traditional metrics often failing to account for semantic and syntactic nuances beyond simple accuracy.

Inadequate handling of synonyms: Insufficient recognition and correct translation of synonyms, affecting naturalness and accuracy of translated text.

Scalability for multilingual translation: Challenges in providing high-quality translations across a large number of languages without a degradation in quality.

Semantic loss during translation: Difficulty in preserving intent of the original content and context, leading to potential loss of semantic meaning.

Cumbersome evaluation metric customization: Complexity in adapting and customizing evaluation metrics to fit the specific needs and contexts of various translation tasks.

Linguistic Diversity: There are thousands of languages in the world, each with its own unique syntax, grammar, and vocabulary. Such a diversity makes it difficult for the known language detection and translation framework to create a universal model for language detection and translation.

Contextual Understanding: Many words and phrases may have different meanings depending on the context in which they are used, which may make it challenging for the LLMs to interpret and translate text accurately.

Lack of Resources: For many languages, there are not enough bilingual text corpora available to train the LLMs. The lack of resources may limit the effectiveness of language translation for less common languages.

Idiomatic Expressions: Many languages may be filled with idioms, cultural references, and colloquial expressions that can be difficult to translate accurately into another language.

Homonyms and Synonyms: Many languages may have words that sound the same or are spelled the same but have different meanings, as well as words that have similar meanings but are used in different contexts. These can pose challenges for accurate language detection and translation.

Grammatical and Structural Differences: Many languages may have different sentence structures, word orders, and grammatical rules. Translating between the languages with vastly different structures may be particularly challenging.

Polysemy and Ambiguity: A single word can have multiple meanings based on the context, making it difficult for computational models to ascertain the correct interpretation without a deep understanding of the surrounding text. Also, it may be difficult to determine which language a word belongs to when it is spelled identically in both languages. In such instances (and especially with shorter text), it might be difficult to detect the language.

Cultural Nuances and Localization: Effectively translating content often requires a nuanced understanding of cultural contexts, which may greatly influence the meaning and reception of a translation.

Evolution of Language: Many languages are not static, and they evolve over time with new words, phrases, and usage patterns emerging continually.

Non-Standard Language and Slang: Informal language, slang, and internet jargon often do not adhere to standard grammar rules and can vary widely from one community to another.

Cognates and False Friends: Cognates are words in different languages that share a similar form and meaning due to a common etymological origin, such as “information” in English and “información” in Spanish. Conversely, false friends look similar but have different meanings, which may mislead the LLMs.

Short Texts Challenge: Language detection models often require a sufficient amount of text to accurately predict the language. In shorter texts, there may not be enough linguistic features to make a correct assessment, and the probability of encountering ambiguous or similar words increases.

Length Sensitivity and Context: The LLMs may be trained on datasets with varied text lengths. However, they might perform poorly on text lengths not well represented in the training data. For very short texts, like tweets or Short Messaging Service (SMS) messages, language detection may become particularly uncertain without additional context.

Orthographic Distinction: A language like Hungarian may use a Latin alphabet with additional accented characters, while the language like English may uses a basic Latin alphabet, and the language like Russian may use the Cyrillic script. Such a use of different scripts may aid in language detection and separation of text segments.

Modeling Script and Language Overlaps: For words using the Latin script found in both Hungarian and English, the language detection models may need to differentiate based on context and frequency of language-specific words.

Language Specificity: The LLMs has to be sensitive to the vocabulary, syntax, and structure unique to each language. For instance, Hungarian has complex morphology with agglutinative characteristics, which is different from the more analytical nature of English and the inflectional morphology of Russian.

Contextual Analysis: Contextual clues might help disentangle which language is being used, especially with shorter bits of text where cognates or loanwords could lead to confusion

In essence language interpretation may be influenced by a variety of factors, including volatility. Volatility refers to how language may change and evolve over time. For example, a word “cool” in English used to primarily mean a lower temperature but has since evolved to also mean something impressive or in style. Similarly, an internet slang word like “LOL” (laugh out loud) or “BRB” (be right back) reflects how digital communication shapes modern language.

Further, a factor diversity encompasses existence of many different languages and wide range of variation within the languages. Diversity includes different dialects, accents, and vocabulary. For example, British English and American English are both forms of English but use different words for same objects. In British English, “lorry” is used to refer to a large vehicle for transporting goods, while in American English, the same object is called a “truck.” Similarly, in British English, “flat” refers to a residential unit, whereas in American English, it is called an “apartment”. In another example is the Chinese language, which includes dialects such as Mandarin, Cantonese, and Hokkien, each with significant differences in pronunciation, vocabulary, and grammar. Another example is the Chinese language, which includes several distinct dialects such as Mandarin, Cantonese, and Hokkien. These dialects differ significantly in pronunciation, vocabulary, and grammar. For instance, a word for “book” in Mandarin is “ [symbol] ” (shū), while in Cantonese, it is “ [symbol] ” (syū), and in Hokkien, it is “ [symbol] ” (sue). Additionally, sentence structures and tones used in these dialects may vary greatly, affecting how the language is spoken and understood in different regions.

Additionally, languages are also inherently complex and grammatically rich. There are numerous challenges and difficulties in interpreting language nuances such as synonyms, which are words with similar meanings like “happy” and “joyful”, and antonyms, words with opposite meanings such as “happy” and “sad”. Further, an example of the challenges and difficulties is polysemy which refers to words with multiple related meanings, such as “light”, which may mean illumination, opposite of heavy, or starting a fire. Interpreting and translating polysemous words may be challenging because meaning depends on context. Misinterpretation of context may lead to incorrect translations or misunderstandings. Another example of the challenges and difficulties is homonymy is another challenge that includes words spelled and pronounced same but with different meanings, like “bat”, which may be a mammal or a sports tool. Homonymy may create confusion in both interpretation and translation, as intended meaning may be deduced from surrounding context. Properly disambiguating homonyms is crucial for accurate communication. Additional challenges include homophones (words that sound the same but have different spellings and meanings), homographs (words that are spelled the same but have different meanings), hyponyms and hypernyms (specific and general terms), metonyms (words used in place of related words), synecdoche (a part representing the whole or vice versa), euphemisms (indirect expressions replacing harsh ones), collocations (words that often go together), idioms (groups of words with established meanings), jargon (special words or expressions used by a specific profession or group), and slang (informal words and phrases restricted to a particular context or group of people). Above-described challenges add further layers of difficulty in language interpretation and translation.

Linguistic complexities such as active versus passive tense and formal versus informal sentences further complicate interpretation. Metaphors and symbolic representations, like using a heart symbol for love, may be interpreted in various ways. Cultural and region-specific differences in word usage, such as “boot” in one zone (e.g., in UK) versus “trunk” in another zone (e.g., US), may lead to misinterpretation. Different spellings in English variants, such as “color” in American English versus “colour” in British English, illustrate how regional preferences affect written communication. Additionally, regional meanings of words may differ, for example, in India, “crib” may refer to both a baby bed and, colloquially, to whining, which may also be used in slang to mean a home or apartment, depending on the context. Different connotations further complicate matters, as seen with a word “bank”, which may denote a financial institution or a side of a river, depending on usage of the word. Further, slang expressions vary widely across regions and communities. For example, “bail” may mean to leave abruptly or to provide financial assistance, depending on the context. Idiomatic expressions also pose challenges, phrases like “kick the bucket” mean “to die”, which is not apparent from the literal interpretation of the words. Sarcasm adds another layer of complexity, as statements like “Great job!” may convey the opposite of praise when spoken with a sarcastic tone. Emotions and sentiments embedded in a message play a crucial role in interpretation. For example, “I'm fine” may signal genuine contentment or hidden frustration, depending on speaker's tone. The manner in which a message is conveyed including its tone and context may affect its meaning. Moreover, possible typos in writing may lead to misunderstandings, such as a missing letter turning “I'm not there” into “I'm not here”, which may create confusion. Understanding of these variations is essential for ensuring accurate communication and effective translation.

Challenges in language translations include ambiguity in language detection, such as in a French phrase “Le chat est mignon”, a word “chat” may refer to a cat or a chat (conversation), potentially confusing translation algorithms. Another challenge is inconsistent translation quality, which becomes apparent when translating idiomatic expressions. Phrases like “It is raining cats and dogs”, when translated literally, lose their intended meaning and may become nonsensical. Translation of less common languages poses its own difficulties. For example, translating languages like Basque, which is linguistically unique, may lead to inaccuracies due to its distinct grammatical and lexical structures. Additionally, contextual understanding adds complexity to translation tasks. For example, the word “run” may mean different things depending on the context it may refer to physical movement or a period of continuous activity, requiring careful interpretation to convey the correct meaning. These challenges highlight the need for sophisticated algorithms and human expertise to ensure accurate and meaningful translations.

Challenges also arise with idioms, homonyms, and synonyms, as well as grammatical and structural differences between languages. For example, translating from English to Japanese, where a verb often comes at the end, may be difficult. Cultural nuances, localization, and words that appear similar but have different meanings (e.g., cognates and false friends/false cognates) add to the complexity. Cognates are words in different languages that share a similar form and meaning due to a common etymological origin. For example, an English word “information” and a Spanish word “información” are cognates. These words (i.e., information and información) look and sound similar and have the same meaning. However, even cognates may sometimes have slight differences in usage or connotation. False Friends/false cognates are words that look similar in two languages but have different meanings. For example, an English word “actual” means “current” or “real”, while in Spanish, “actual” means “present” (in time), not “real”. Another example is an English word “library” and a French word “librairie”, while they look similar, “librairie” means “bookstore” in French, not a place where books are borrowed.

The known language detection frameworks need sufficient text to accurately predict the language, which is problematic for short texts in minority languages. The known language detection models consider features like syntax, grammar, and common phrases, which are more apparent in longer texts. Minority languages may be missed, especially when mixed with dominant ones. Orthographic distinction, language overlaps, and contextual analysis may affect language detection. For example, words spelled the same in different languages may confuse the known language detection models, while contextual clues may help identify the language. Morphologically complex languages, such as Finnish, Turkish, or Hungarian, use inflections to express grammatical relationships, presenting challenges for translation algorithms.

Different types of languages present challenges when translating into or from English due to their distinct linguistic features. Isolating or analytic languages, such as Chinese and Vietnamese, rely on a one-to-one correspondence between words and their meanings, using word order and context rather than inflections or affixes. In contrast, English combines analytic elements with inflectional aspects, making it necessary to adjust word order and prepositions to convey equivalent meanings. Agglutinative languages like Turkish and Finnish, use affixes attached to base words to express grammatical relationships and nuances. Each affix adds specific meaning or function, which may be challenging to translate into English. English relies on word order and prepositions for grammatical expression, rather than using affixes, complicating direct translation of agglutinative structures. Fusional or inflectional languages, such as Latin and Russian, use inflections to convey grammatical information like tense, case, and number. In these languages, a single word can carry extensive grammatical information. English, on the other hand, uses word order and auxiliary verbs to express these grammatical relationships, making it difficult to translate inflectional forms directly into English. Polysynthetic languages, such as Inuit and Nahuatl, combine multiple concepts into a single, long word, expressing what may be a full sentence in English. This complex word formation may be challenging to translate into English, which tends to break down ideas into phrases or sentences, making it difficult to capture full meaning in a single translation. Tonal languages, like Mandarin Chinese, use pitch variations to differentiate words that sound the same. English, which is not a tonal language, may lose these pitch-based distinctions in translation, leading to potential misunderstandings or loss of meaning. These linguistic differences highlight the intricacies involved in translation. A high degree of idiomatic and context-dependent usage of English may further complicate translating from languages with more consistent grammatical rules. Additionally, the polysynthetic nature of some languages, where complex ideas are expressed in single words, poses challenges for translating into English, which uses phrases and sentences to convey complex ideas. It is important to understand these diverse linguistic features for achieving accurate and meaningful translations.

All the above explained factors contribute to the challenges in adapting evaluation metrics, which are initially designed for classical Machine Learning (ML) or AI applications, for use in generative AI. In this context, semantic meaning becomes crucial, necessitating adjustments to the known language detection and translation models. Therefore, understanding and preserving semantical nuances (subtle meaning distinctions and multiple interpretations), linguistic nuances (details and complexities of language use), lexical integrity (correct use of individual words), syntactical quality (grammar and word order), and textual quality (clarity and effectiveness) are essential.

Therefore, language detection and evaluating language translation performance of the LLMs using metrics may not be the trivial tasks.

Implementations of the present disclosure provide an effective language detection and translation framework that addresses the above-described challenges associated with translating text/data accurately, evaluating a quality of language translation, and identifying languages reliably in a multi-lingual environment.

The proposed language detection and translation framework may enable effective language detection and evaluation of language translation quality of the LLMs using improvised metrics.

The proposed language detection and translation framework may use multiple approaches such as noise removal techniques, ensemble voting, weighted post-processing, and advanced NLP models for performing language detection on data (e.g., multilingual data) received in a request/prompt. Such approaches may have capabilities to handle the complex multilingual data. Due to which, the language detection may be performed with high accuracy and efficiency. Further, the proposed language detection and translation framework may not only improve accuracy and efficiency of the language detection but may also support a broader range of languages and text types.

The proposed language detection and translation framework may use the improvised metrics for evaluation of translation outputs, which are generated by performing the language translations using the LLMs. The metrics may include numerical metrics, semantic metrics, boosting metrics, and/or the like. Usage of such metrics for the evaluation may improve accuracy and contextual understanding and enhances ability of the LLMs in performing the language translations with high precision. Furthermore, the proposed language detection and translation framework may address the challenges related to polysemy, contextual ambiguity, and translation evaluation, offering a comprehensive solution that scales effectively across multiple languages and text types. In addition, the proposed language detection and translation framework may use robust methods for handling multilingual content and reducing semantic loss during translation, while addressing the limitations of the known language detection and translation frameworks.

The proposed language detection and translation framework may involve an efficient scoring mechanism for generating score values for each translation output and an overall SAFE score value for each translation output based on the score values. The SAFE score value may be used to assess quality, accuracy, performance, and/or the like of the translation output, thereby assessing translation quality of the LLMs. Further, the scoring mechanism may improve an overall translation quality of LLMs.

Therefore, the proposed language detection and translation framework may provide a valuable tool for enterprises requiring high-quality language detection and translation in a diverse and evolving linguistic landscape.

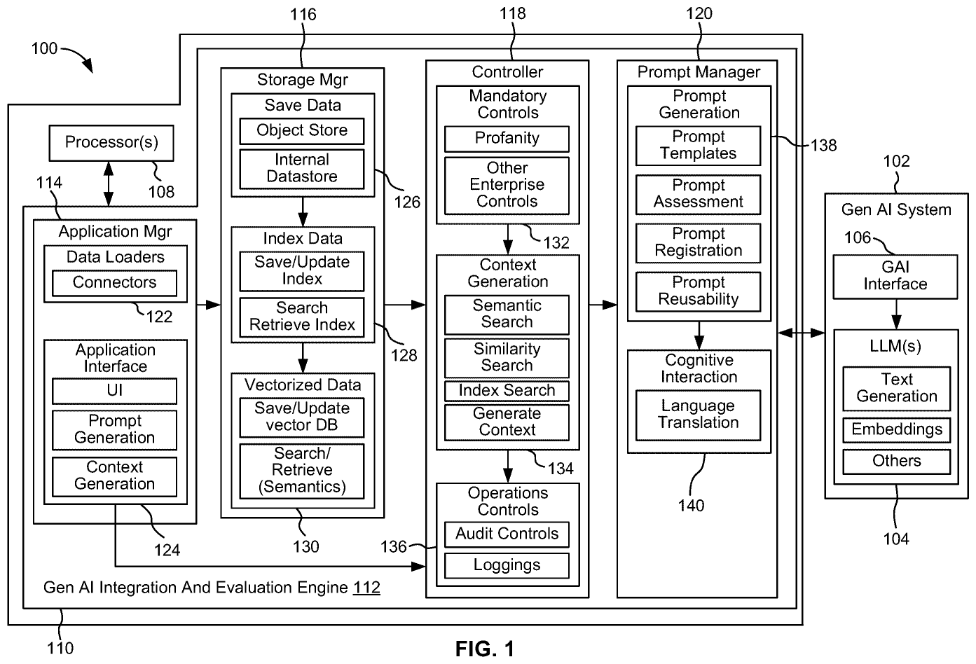

FIG. 1 illustrates an example architecture of a language detection and translation system 100, in accordance with implementation of the present disclosure. The language detection and translation system 100 may enable language detection and language translation tasks with high accuracy and quality.

As depicted in FIG. 1, the language detection and translation system 100 may be communicatively coupled to a Generative Artificial Intelligence (Gen AI) system 102. The Gen AI system 102 includes Large Language Models (LLMs) 104, and a Gen AI interface 106. The LLMs 104 may be used for performing the language translation tasks. The LLMs 104 may be hosted on the same or a different hosting infrastructure. A non-limiting example of the hosting infrastructure may include cloud computing platforms. The LLMs 104 may be accessed through the Gen AI interface 106.

In some examples, the LLMs 104 may be integrated in digital assistants (for example, chatbots), replacing traditional rule-based systems to provide textual responses to a user input. The LLMs 104 may generate human-like text and perform various Natural Language Processing (NLP) tasks (for example, translation, question-answering, and/or the like). In some examples, the LLMs 104 refer to models that use deep learning techniques and have a plurality of parameters, which may range from millions to billions. The LLMs 104 may capture complex patterns in language and produce text that is often indistinguishable from that written by humans. The produced text may be processed through a deep learning architecture such as, a recurrent neural network (RNN), a transformer model, and/or the like.

In accordance with implementations of the present disclosure, the LLMs 104 may receive requests/queries from the language detection and translation system 100. In response to the received request, the LLMs 104 may provide responses/results to the language detection and translation system 100. The requests may include requests for translation of data in one or more languages and the responses may include one or more translated outputs indicating translated data. In some examples, the requests/queries may be received as processed text prompts through an Application Programming Interface (API).

Still referring to FIG. 1, the language detection and translation system 100 includes a processor 108 and a memory 110. The processor 108 may include one or more processors. In some examples, the processor 108 may include, for example, microprocessors, microcomputers, microcontrollers, digital signal processors, central processing units, state machines, logic circuits, and/or any devices that manipulate data or signals based on operational instructions. The memory 110 may be a non-volatile memory or a volatile memory. Examples of the non-volatile memory may include, but are not limited to, a flash memory, a Read Only Memory (ROM), a Programmable ROM (PROM), Erasable PROM (EPROM), and Electrically EPROM (EEPROM) memory. Examples of the volatile memory may include, but are not limited, a Dynamic Random Access Memory (DRAM), and a Static Random-Access Memory (SRAM). The memory 110 may be communicatively coupled to the processor 108 and store instructions, which upon execution by the processor 108, cause the processor 108 to perform various operations described in the present disclosure.

Further, the memory 110 includes a Gen AI integration and evaluation engine 112. The instructions stored in the memory 110 may define operations of the Gen AI integration and evaluation engine 112. The Gen AI integration and evaluation engine 112 includes an application manager 114, a storage manager 116, a controller 118, and a prompt manager 120.

In some implementations, the application manager 114 may enable the language detection and translation system 100 to interact with the Gen AI system 102 through the controller 118 and the prompt manager 120. In some examples, the storage manager 116 stores various types of data that the application may access from the application manager 114. The data may include the prompts and the responses generated using the LLMs 104 of the Gen AI system 102.

Further, the application manager 114 includes a data loaders module 122 and an application interface module 124. In some examples, the data loaders module 122 may include connectors that enable data storage and retrieval with the storage manager 116. Examples of the connectors may include, but are not limited to, a relational database management system (RDBMS) connector, a not only Structured Query Language (SQL) (non-SQL/NoSQL) connector, a secure file transfer protocol (SFTP) connector, a bulk data connector, and a stream data connector. In some examples, the application interface module 124 may enable communication with the controller 118. The application interface module 124 includes a user interface (UI), a prompt generation, and context generation. In some examples, the UI may enable a user (e.g., an agent of the enterprise) to interact with an application (e.g., including chatbot, a messaging application, a social networking application, and/or the like) and/or access dashboards for inputting the requests and receiving the responses for the requests. In some examples, the prompt generation may enable provisioning of the prompts that may be used to query the LLMs 104. In some examples, the context generation may enable provisioning of context from the prompts, which may be used to query the LLMs 104 (e.g., context of an enterprise, context of an enterprise operation).

Further, the storage manager 116 includes a save data module 126, an index data module 128, and a vectorized data module 130. In some examples, the save data module 126 includes an object store (e.g., to store data objects, binary large objects (BLOBs)) and an internal datastore. In general, the save data module 126 may represent storage of the data (e.g., the prompts and the associated results) that may be accessed by the application in the application manager 114 for execution of enterprise operations. In some examples, the index data module 128 includes a save/update index and a search/retrieve index. The save/update index may be used to index the data that is stored in the storage tier for search and/or retrieval using the search/retrieve index. In some examples, the vectorized data module 130 includes a save/update vector database (DB) sub-module and a search/retrieve sub-module. In some examples, vectors may be provided for the data stored in the storage manager 116, each vector being a n-dimensional representation of respective data (also referred to as an embedding). The vectors may be used for search (e.g., semantic search) and retrieval of the data. For example, the vectors may be compared (e.g., using dot product) to determine similarity therebetween.

The controller 118 includes a mandatory controls module 132, a context generation module 134, and an operations control module 136. In some examples, the mandatory controls module 132 represents modules that are determined to provide mandatory functionality for interactions with the Gen AI system 102. In some examples, the context generation module 134 includes functionality for semantic search, similarity search, index search and context generation. For example, the context generation module 134 may generate a context for the enterprise and/or an enterprise operation (e.g., based on the data stored in the storage manager 116), and the context may be used to provide enterprise-specific and/or operation-specific responses from LLMs 104 of the Gen AI system 102. In some examples, the operations controls module 136 provides operations functionality, such as audit controls and logging.

The prompt manager 120 includes a prompt generation module 138 and a cognitive interaction module 140. In some examples, the prompt generation module 138 includes prompt templates, prompt assessment, prompt registration, and prompt reusability. The prompt generation module 138 may enable the prompts to be generated using a prompt template that is specific to the LLMs 104 that are to be queried. The prompts may be assessed (e.g., for quality, accuracy) before being used to query the LLMs 104 and may be registered and stored for reuse (e.g., avoid consumption of resources in recreating the prompts for subsequent queries). In some examples, the cognitive interaction module 140 may provide for content processing, for example, language translation.

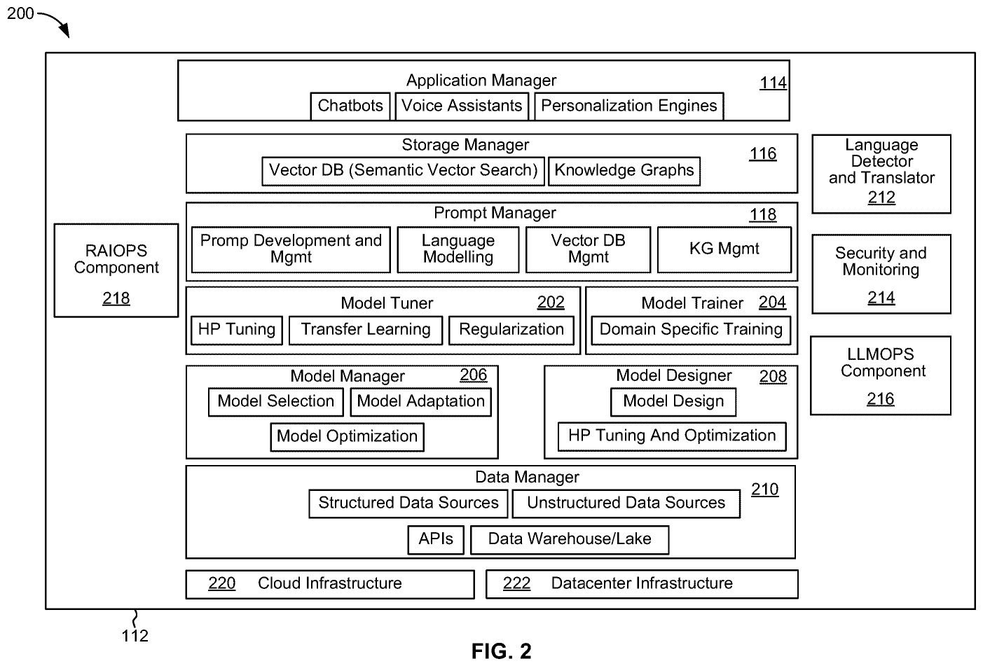

FIG. 2 illustrates an example architecture 200 including the Gen AI integration and evaluation engine 112 of the present disclosure. The example architecture 200 of FIG. 2 is representative of a multi-layered, end-to-end framework of the Gen AI integration and evaluation engine 112. In FIG. 2, the Gen AI integration and evaluation engine 112 includes the application manager 114, the storage manager 116, the prompt manager 120, a model tuner 202, a model trainer 204, a model manager 206, a model designer 208, a data manager 210, a language detector and translator 212, a security and monitoring component 214, an LLM operations (LLMOPS) component 216, a responsible AI Operations (RAIOPS) component 218, a cloud infrastructure component 220, and a datacenter infrastructure component 222.

The application manager 114 may execute logic and project specific implementation of the application of the enterprise. In some examples, the application manager 114 includes non-limiting example applications of chatbots, voice assistants, and evaluation engines. In some examples, a chatbot may use NLP to simulate human-like conversations with the user of the enterprise. In some examples, a voice assistant may use speech recognition and synthesis to enable the user to interact with the application through spoken commands and responses. In some examples, an evaluation engine may provide results of evaluation of the LLMs 104 to the user. In an implementation herein, the results of evaluation of the LLMs 104 may indicate the translation outputs and quality of each of the translation outputs generated using the LLMs 104.

The storage manager 116 includes a vector database (DB) (e.g., to support semantic vector search) and one or more Knowledge Graphs (KGs). The vector database may be used to store the vectors. In some examples, a vector may be described as an n-dimensional, numerical representation of information (e.g., n=1536). In some examples, a KG may be described as a representation of real-world entities and their relationships in a database and used to capture the context of any conversation and identify similar relations. In some examples, the storage manager 116 may be described as a context setting layer that hosts an organizational knowledge as a searchable interface. For example, the prompts to the LLMs 104 may be augmented with domain data and/or organizational data through the storage manager 116. In some examples, context may be provided for the prompts in the form of few-shot examples to provide a few-shot prompt. In some examples, providing the context with the prompts may be referred to as few-shot learning. In some examples, few-shot examples may be determined from the vector database, which stores information as multidimensional vectors (also referred to as embeddings). In some examples, few-shot examples may be provided based on data stored in a knowledge graph.

The prompt manager 120 includes prompt development and management, language modelling, vector DB management, and knowledge graph management. The prompt manager 120 may provide the prompts that represent appropriate queries in an appropriate sequence to the LLMs 104. The prompt manager 120 connects with the vector DB and the knowledge graphs of the storage manager 116 to provide, for example, domain-based context and other details that may be provided to the LLMs 104 to enable the LLMs 104 correctly interpret and answer the prompts. In this example, the user input may be processed to determine sentiment and/or emotional state and a prompt may be provided based thereon. The sentiment and/or emotional state may be determined only based on an explicit consent received from the user.

The model tuner 202 includes hyperparameter (HP) tuning, transfer learning, and regularization. In some examples, the LLMs 104 may be fine-tuned for one or more specific tasks, for example herein, language translation. In some examples, fine-tuning may be described as a process, in which task-specific training data may be used to fine-tune the LLMs 104 (e.g., a pre-trained foundational LLM). Fine-tuning may enable the LLMs 104 to answer in a specific format and structure that may be suitable for organizational needs of the enterprise.

The model trainer 204 may include domain-specific training capabilities. For example, some of the LLMs 104 may be customized and fine-tuned to focus on specific domains. Such a customization may allow the LLMs 104 to generate responses and formats tailored to particular fields or subjects.

The model manager 206 includes model selection, model adaptation, and model optimization. In some examples, the model manager 206 enables access to the LLMs 104 that are pre-trained and offered as managed services by multiple third parties (vendors) (e.g., OpenAI, SambaNova, ScaleAI). Such LLMs 104 may be described as off-the-shelf LLMs 104 that are accessed as a service (e.g., through respective APIs).

The model designer 208 includes model design and hyperparameters (HP) tuning and optimization. In some examples, the model designer 208 may enable downloading and customization of the LLMs 104 available as public models. The customization may be performed, for example, in terms of training, re-training, fine-tuning, and/or the like.

The data manager 210 enables access to structured data sources, unstructured data sources, APIs, and data warehouses and/or data lakes. In some examples, building an application that leverages the LLMs 104 and that is powered by knowledge and context of an enterprise may require access to a knowledge base of the enterprise. The data manager 210 may enable such data access for the application.

In some examples, the cloud infrastructure component 220 may align with the data manager 210 and enable storing of the data using cloud infrastructures. Examples of the cloud infrastructures may include, without limitation, Microsoft Azure, Amazon Web Services (AWS), and/or Google Cloud Platform (GCP). In general, the cloud infrastructure may provide tools, services, and security to host the application and store the associated data in a cloud environment. In some examples, the datacenter infrastructure component 222 includes on-premises datacenters for hosting the applications and/or the LLMs 104 in enterprise-specific datacenters.

The security and monitoring component 214 may include enterprise security, data and model privacy, threat management, and monitoring. In some examples, the security and monitoring component 214 addresses threats and security concerns regarding the applications and their use of the LLMs 104, and how the LLMs 104 themselves are storing and using the data.

The LLMOPs component 216 includes model management, prompt management, fine-tuning and customization, and monitoring. In some examples, the LLMOPs component 216 addresses considerations and capabilities needed to operationalize LLM projects including the applications, the data, and the LLMs 104.

The RAIOPS component 218 may address potential shortcomings of the LLMs 104. The RAIOPS component 218 may decide on what and how to evaluate the responses generated by the LLMs 104 to ensure that the results are acceptable (e.g., factually, socially) for use in the application.

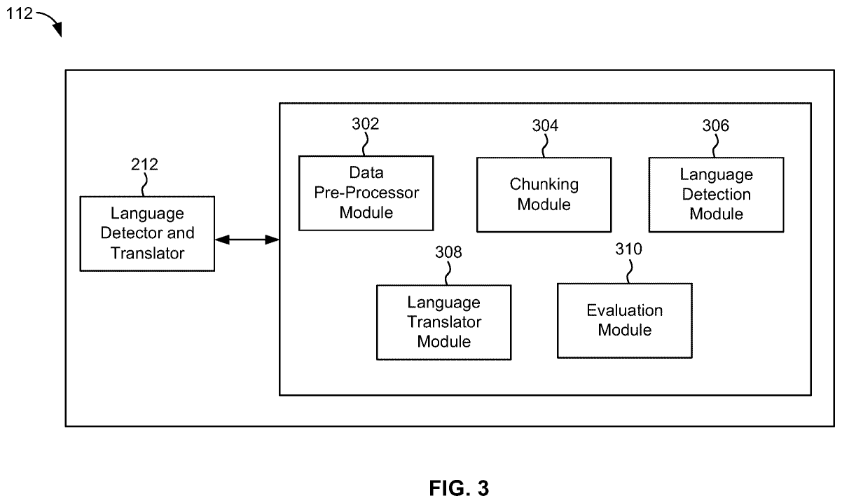

In accordance with implementations of the present disclosure, the language detector and translator 212 may enable the language detection and translation tasks, which is described in detail in conjunction with FIG. 3.

FIG. 3 depicts an example block diagram of the language detector and translator 212 in the Gen AI integration and evaluation engine 112 for the language detection and translation tasks, in accordance with implementations of the present disclosure. The language detector and translator 212 may receive the request/prompt for language translation through the application manager 114 and generate the translation output for the request. The language detector and translator 212 includes a data pre-processor module 302, a chunking module 304, a language detection module 306, a language translator module 308, and an evaluation module 310.

The data pre-processor module 302 may identify the data in the received request/prompt. The data may be in any of languages reliably in a multilingual environment. The data may include text, sentences, words, phrases, characters, and/or the like. The data pre-processor module 302 may pre-process the data by removing noise from the data. The noise referenced herein may include irrelevant or extraneous information that may impede accurate language detection and translation. The data pre-processor module 302 may retain stop words in the data, as the stop words may add value to translation of the language. The data pre-processor module 302 may convert the pre-processed data into its vector representation.

Once the data is pre-processed, the chunking module 304 may split the pre-processed data into multiple chunks. Each of the chunks may correspond to a subset of the data. The subset of the data may include data associated with at least one sentence or a sequence of a preconfigured number of words. In some examples, the chunking module 304 may split the pre-processed data into the chunks based on upon a type of alphabets identified in the data. The chunking module 304 may also remove any irrelevant information data from each of the chunks.

To address a challenge of processing text data that includes minority, non-Latin scripts within documents containing multiple languages, including dominant languages spanning several sentences and paragraphs with embedded minority languages, the chunking module 304 may identify whether the data contains any non-Latin characters. If non-Latin characters are identified, the chunking module 304 may then divide the data into smaller parts, with special attention given to removing any unnecessary information, such as extra spaces. The chunking module 304 may further differentiate between data segments containing Latin characters and data segments with non-Latin characters. If a data segment contains Latin characters, the chunking module 304 may split that data segment into even smaller chunks. Conversely, the data segments with only non-Latin characters may be retained in their original form. The chunking module 304 may ensure that all the data segments, whether the data segments with Latin characters or the data segments with non-Latin characters, may be properly identified and segmented, thereby effectively handling minority non-Latin scripts within larger datasets. The chunking module 304 may enhance overall efficiency of the language detector and translator 212 and the LLM, enabling accurate identification and processing of languages such as Chinese, Japanese, Russian, Korean, Thai, and other languages.

After splitting the data into the chunks, the language detection module 306 may identify the language of each of the chunks. In some examples, the language detection module 306 may identify the language of each of the chunks using language detection libraries. In an example, the language detection module 306 may use language detection models to identify languages present in a document. The primary purpose of using the language detection module 306 is to ensure that only documents not written in a target translation language may be forwarded to the LLMs for translation. For example, if the target translation language is English, the language translation module 306 may filter out documents that are already in English, preventing the documents from being unnecessarily processed by the LLMs. Conversely, if a document contains non-English scripts or text, the document may be sent to the LLM for translation, while the text in the target language may remain unchanged. This approach helps in optimizing translation process and avoid redundant processing of text that is already in the desired language.

In some other examples, the language detection module 306 may use an ensemble of language detection models (e.g., NLP models) for identifying the language of a chunk. To illustrate, the language detection module 306 may input the data of the chunk to the language detection models and receive votes from the language detection models. The votes may be for same or different classes. Each of the class may indicate the language. The language detection module 306 may identify the language of the chunk based on the votes or the classes.

In some examples, for identifying the language of the chunk, the language detection module 306 may evaluate the votes of the language detection models using an ensemble/majority polling mechanism. The majority polling mechanism may function based on a consideration that a combination of the language detection models may provide a robust and accurate prediction than a single language detection model, therefore a high performance may be achieved in detecting the language while reducing a risk of an unfortunate choice of language detection model. In accordance with the majority polling mechanism, the language detection module 306 may identify the class which received a maximum number of or majority of votes. The language detection module 306 further identifies the language indicated by the identified class as the language of the chunk.

For example, consider a scenario where three language models contributed the votes for a “class 1” or a “class 2” indicating English or Spanish, two language models contributed the votes for the “class 1” indicating English, and a language model contributed a vote for a class 2 indicating Spanish. In such a scenario, the language detection module 306 may identify English as the language of the chunk, as the majority number of the votes have been contributed to the “class 1” indicating English. Therefore, the language of the chunk may be identified using performance or confidence of each of the language detection models.

In some examples, for identifying the language of the chunk, the language detection module 306 may evaluate the classes corresponding to the votes of the language detection models using a weighted majority polling. The weighted majority polling may function by assigning different weights to the classes voted by the language detection models, instead of assigning equal importance to all the votes of the language detection models. In accordance with the weighted majority polling, the language detection module 306 may assign weights to each of the classes based on external criteria such as known prevalence, importance, performance of the respective language detection models, prediction confidence values associated with the respective language detection models, or the like. When the votes are contributed by the language detection models for each class, the language detection module 306 may multiply the respective class with a class weight predetermined for the class. Upon multiplying all the classes with the respective predetermined class weights, the language detection module 306 may select the class with the highest total weights among the other classes and identify the language indicated by the selected class as the language of the chunk. The weighted majority polling may grant an additional impact to the classes reflecting their expected significance or likelihood within the data set.

For example, consider a scenario, where English and Spanish are the most common languages in the subset of the data associated with the chunk and the class weights may be predetermined for classes 1 and 2 as 0.7 and 0.5, respectively. In such a scenario, if two language detection models contribute votes for the “class 1” indicating English and a language detection model contribute a vote for the “class 2” indicating Spanish, then wights of the “classes 1 and 2” may result in (2*0.7) and (1*0.5), respectively. In such a scenario, the language detection module 306 may identify English (as indicated by the “class 1”) as the language of the chunk. Therefore, the language detection module 306 may identify the language of the chunk by integrating external knowledge about class distribution into a decision-making process of the ensemble of the language detection models.

When the language of each of the chunks is identified, the language translator module 308 may generate the translation output for each of the chunks using the LLM 104. The translation output of the chunk may include the respective subset of data translated in a preferred target translation language.

Once the translation output for each of the chunks is generated, the evaluation module 310 may evaluate the translation output of each of the chunks. Evaluating the translation output of a chunk is described in detail below.

For evaluation, the evaluation module 310 may access a reference translation from the memory 110 (depicted in FIG. 1). The reference translation may be a ground-truth, which may be in a predetermined language, for example, English. The evaluation module 310 may evaluate the translation output with respect to the reference translation.

In an implementation herein, evaluation of the translation output with respect to the reference translation may include selecting evaluation data from the translation output, translating the selected evaluation data into the predetermined language being supported by the reference translation, and evaluating the translated evaluation data with respect to the reference translation. In some examples, the evaluation data may be selected from the translation output using a bootstrap resampling method. In accordance with the bootstrap resampling method, the evaluation module 310 may select the evaluation data from the translation output through resampling with replacement. For example, using the bootstrap resampling method, the evaluation module 310 may estimate sampling distribution on the translation output by iteratively fetching samples (also referenced herein as bootstrap sample) with replacement from the translation output. Therefore, each sample may be generated by randomly fetching original set of data points from the translation output. As the evaluation module 310 generates each sample by randomly fetching the original set of data points, some of the original set of data points from the translation output may be selected multiple times while others may not be selected at all. For example, consider a scenario where the translation output includes data points of 100 accuracy scores. In such a scenario, the evaluation module 310, using the bootstrap resampling method, may create the samples of a same size by randomly sampling/fetching the datapoints of 100 accuracy scores with replacement. Due to which each sample be ensured with a possible variation of the original set of data points from the translation output. The samples derived using the bootstrap resampling method may be the evaluation data selected from the translation output. In some examples, the evaluation module 310 may use libraries (e.g., Hugging face, John Snow, and/or the like) for translating the translation output to the predetermined language (e.g., to English via Marian). Hereinafter in FIG. 3, it should be noted that evaluation of the translation output with respect to the reference translation may refer to evaluation of the selected and translated evaluation data from the translation output with respect to the reference translation.

Further, the evaluation module 310 may evaluate the translation output with respect to the reference translation using metrics and generate score values based on the evaluation. The metrics may be recommended by the RAIOPS component 218 and the LLMOPS component 216. Therefore, the metrics may be improved/enhanced RAIOPS integrated with LLMOPS metrics.

Each of the metrics may be used for evaluating the translation output with respect to the reference translation for one or more translation quality aspects and generating the score values. In some examples, the one or more translation quality aspects may include a precision, a recall, a semantic quality of the translation output, a synonymy, a paraphrasing, a word order, an under-translation, an over-translation, a number of insertions required, a number of deletes required, a number of substitutions required, a number of shifts required, a number of edits required (e.g., an edit distance score), information preserved or lost in the translation output, a fluency of the translation output, a lexical quality/similarity, a semantic similarity, a syntactic structure, and/or the like of the translation output. Among the translation quality aspects, the precision and recall may act as important factors in evaluating quality of the translation output and when different translation tasks may require different trade-offs. The precision may indicate how many portions of the translation output may be relevant. The recall may indicate how many portions of the translation output selected for language translation. The selected evaluation data may include words, phrases, and/or the like. For example, the precision may indicate a proportion of words or phrases in the translation output that are also present in the reference translation. A high precision may indicate that the translation output is accurate in terms of including the correct words or phrases, but the translation output does not account for all the information that may be present in the reference translation. For example, if only words are translated using the LLM 104, the high precision may be achieved by accurately translating the words, but other relevant words may be missed, resulting in low precision. The recall may measure proportion of words or phrases in the reference translation that are present in the translation output. For example, a high recall may imply that the translation output captures a larger portion of the information from the reference translation. However, achieving the high recall may not necessarily guarantee accuracy. For example, even if the LLM 104 is used to translate every word from a source sentence, even the words the LLM 104 is not confident about, a high recall may be achieved but with low precision.

In some examples, the evaluation module 310 may use the bootstrap resampling method for determining variability and precision of the metric. For determining the variability and precision of a metric, the evaluation module 310, using the bootstrap resampling method, may estimate the sampling distribution on the metric. The sampling distribution may be estimated on the metric by computing statistics of interest (e.g., mean accuracy) for each sample of the metric. By analyzing the sampling distribution of the statistics across the samples, the evaluation module 310 may determine the variability and precision of the metric. For example, generating “1000” samples from original accuracy scores for the metric and calculating the mean accuracy for each sample may result in obtaining the sampling distribution of mean accuracy values. Such a sampling distribution may provide a detailed view of how the mean accuracy may vary and help in understanding reliability of the metric.

In some other examples, the evaluation module 310 may use the bootstrap resampling method for determining the variability of the metric and constructing confidence intervals for the metric. By analyzing the sampling distribution of the statistics across the samples of the metric, the evaluation module 310 may determine how much the metric is likely to fluctuate or vary. For example, the evaluation module 310 may determine the sampling distribution of the statistics across the samples of the metric by calculating a standard deviation of the mean accuracy scores from 1000 samples. Such a sampling distribution may determine the variability of the metric. In addition, the evaluation module 310 may construct the confidence interval, for example, 95% confidence interval. The confidence interval may indicate a range within which a true mean accuracy is expected to fall with a certain probability. Determining the variability of the metric and constructing the confidence level may enable a more comprehensive assessment of performance of the translation output.

In accordance with implementations of the present disclosure, the metrics used for evaluating the translation output with respect to the reference translation may include Bilingual Evaluation Understudy (BLEU), Recall-Oriented Understudy for Gisting Evaluation (ROUGE), General Language Evaluation Understanding (GLEU), Metric for Evaluation of Translation with Explicit Ordering (METEOR), Cross lingual Optimized Metric for Evaluation of Translation (COMET), Translation Edit Rate (TER), Character n-gram F-score (CHRF), Word Error Rate (WER), Match Error Rate (MER), Word Information Lost (WIL), Word Information Preserved (WIP), Character Error Rate (CER), Hybrid Evaluation Metric for PEriodic Order and Recall (hLEPOR), synonym match, Multilingual Bert Sentence Transformer, Multilingual University Sentence Encoder, Bert-Word embeddings, sentence encoder, Bert synonym extractor, Multilingual paraphrasing, Multilingual textual entailment, paraphrase, visualization metrics (e.g., Gensim topic modeling with pyLDAvis for visualization), textual entailment, and/or the like.

Among the above-described metrics, the metrics like BLEU, GLEU, METEOR, COMET, TER, CHRF, WER, MER, WIL, WIP, CER, and hLEPOR may be referenced herein as numerical metrics/scoring metrics. Based on evaluation performed using such metrics, the evaluation module 310 may generate the score values like a BLEU score, a GLEU score, a METEOR score, a COMET score, a TER score, a CHRF score, a WER score, a MER score, a WIL score, a WIP score, a CER score, and a hLEPOR score. The other metrics like the Multilingual Bert Sentence Transformer, the Multilingual Universal Sentence Encoder, the Bert-Word embeddings, Bert synonym extractor, the Multilingual paraphrasing, and the Multilingual textual entailment, the textual entailment, the paraphrase, the visualization metrics, the textual entailment may be referenced herein as semantic metrics. Using the semantic metrics, the evaluation module 310 may perform the evaluation by considering semantic similarity of words or sentences (of the translation output) in high dimensional vector embedding space with cosine similarity. The semantic metrics may support multiple languages. For example, the Multilingual Universal Sentence Encoder, the sentence encoder, and Bert synonym extractor may support 15, 50, and 102 languages, respectively.

The evaluation module 310 may use the BLEU to determine how much of the translation output is correct, while considering the aspect like the precision. The evaluation module 310 may also use the BLEU to determine an overlap of n-grams (groups of n words) between the translation output and the reference translation. Based on the evaluation of the BLEU, the evaluation module 310 may generate the score value like a BLEU score. The BLEU score may include two or more BLEU scores, for example, BLEU 1 (unigram), BLEU 2 (bigrams), BLEU 3 (trigrams), BLEU 4 (4-grams), corpus BLEU (corpus level). In some examples, a high BLEU score may indicate that many of the n-grams in the translation output match those in the reference translation, indicating a high precision suggesting good vocabulary and phrasing. Conversely, a low BLEU may indicate a lack of precise vocabulary or phrasing in the translation output. For example, consider that the translation output and the reference translation include “The cat sat on the rug” and “The cat sat on the mat,” respectively. In such a case, the evaluation module 310 may generate a low BLEU score, as “on the rug” in the translation output does not match with “on the mat.”

The evaluation module 310 may use Recall-Oriented Understudy for Gisting Evaluation (ROUGE) (e.g., ROUGE-N, ROUGE-S, ROUGE-L, ROUGE-W) to determine how much of the reference translation has been captured by the translation output, while considering the aspect like the recall. The evaluation module 310 may also use the ROUGE for evaluating automatic summarization, which may be used for the language translation and measure recall of n-grams. Further, based on the evaluation of the translation output with respect to the reference translation using the ROUGE, the evaluation module 310 may generate the score value like a ROUGE score. A high ROUGE score may indicate that the translation output may capture much of the content of the reference translation, suggesting good recall. Further, the high ROUGE score may indicate a comprehensive and complete translation and suggest that the translation output is both accurate and complete, with good synonym usage and word order. The low ROUGE score may indicate that the translation output may be missing important content from the reference translation. For example, consider that the translation output and the reference translation include “The cat sat” and “The cat sat on the mat,” respectively. In such a case, the evaluation module 310 may generate a low ROUGE score, as “on the mat” is missing in the translation output.

The evaluation module 310 may use the METEOR for stemming, synonymy, and paraphrasing of the translation output. The METEOR may emphasize the precision and the recall, not just of unigrams. Using the METEOR, the evaluation module 310 may also generate a penalty for sentences in the translation output that are too long or too short. Using the METEOR, the evaluation module 310 may align the words and phrases between the translation output and the reference translation and generate the score value like a METEOR score based on the alignment. Further, the evaluation module 310 may use the METEOR to measure precision, recall, synonymy, paraphrase, word order, and/or the like and generate the METEOR score. A high METEOR score may indicate that the translation output is accurate (e.g., high precision) and complete (e.g., high recall). The high METEOR score may also indicate that the translation output aligns well with the reference translation in terms of word choice and word order, accurately translating phrases and maintaining word order. A low METEOR score may indicate issues with synonym usage, word order, or completeness of the translation output. For example, consider that the translation output and the reference translation include “On the mat, the cat sat” and “The cat sat on the mat”, respectively. In such a case, the evaluation module 310 may generate a high METEOR score as the translation output accounts for reordered phrases.

The evaluation module 310 may use the GLEU for evaluation of shorter sentences in the translation output. The evaluation module 310 may calculate the score value like a GLEU score by comparing n-grams found in the translated evaluation data with n-grams present in the reference translation and in the data identified from the request. If the n-grams found in the translated evaluation data match with the n-grams present in the reference translation and in the data identified from the request, then the evaluation module 310 may calculate a high GLEU score. Further, the evaluation module 310 may use the GLEU for evaluating and assigning a penalty for over-translation and under-translation. Further, based on the evaluation of the translation output with respect to the reference translation using the GLEU, the evaluation module 310 may generate the score value like a GLEU score. A high GLEU score may indicate a high degree of n-gram overlap with the reference translation. However, the GLEU is more sensitive to shorter sentences. Therefore, the high GLEU score may indicate that the translation of shorter sentences is precise, while suggesting accuracy in the translation of short phrases or sentences. A low GLEU score may indicate problem with the accuracy of short phrases or sentences in the translation output. For example, consider that the translation output and the reference translation include “The cat sat on the mat and the mat was blue” and “The cat sat on the mat,” respectively. In such a case, the evaluation module 310 may generate a low GLEU score, as “the mat was blue” may be an extra information present in the translation output (e.g., over-translation).

The evaluation module 310 may use the COMET to predict manual evaluation scores. In some examples, the COMET may include a neural network model, which may be trained on a large multilingual dataset with user/human-annotated quality scores for the language translations.

The evaluation module 310 may use the TER to measure a number of edits required to change the translation output into the reference translation and generate the score value like a TER score. A high TER score may indicate less edits and conversely a low TER score may indicate more edits. For example, consider that the translation output and the reference translation include “The cat sit on mat” and “The cat sat on the mat”, respectively. In such a case, the evaluation module 310 may generate the TER score of 0.33, as two edits may be required to replace “sit” with “sat” and add “the” before “mat.”

The evaluation module 310 may use the CHRF to perform character-level analysis on the translation output. Further, the CHRF may be suitable for evaluation of the translation output, which is in, for example, Chinese, or Japanese where there are no spaces. The CHRF may emphasis the precision, the recall, and a beta parameter that determine a balance between the precision and the recall. Evaluation with the CHRF may provide a different perspective of evaluation, considering a fidelity of the language translation at a character level. Due to which, errors like typos, misspellings, and/or the like may be determined. Based on the evaluation performed using the CHRF, the evaluation module 310 may generate the score value like a CHRF score. The CHRF score may be a character-based version of a F-score (e.g., a harmonic mean of precision and recall). A high CHRF score may suggest that the translation output may have a respectable balance of precision and recall at the character level. Also, the high CHRF score may indicate a character-level accuracy and suggest minimal character-level errors like misspellings or incorrect use of special characters. A low CHRF score may suggest character-level errors in the translation output. For example, consider that the translation output and the reference translation include “Th cat sit on mat” and “The cat sat on the mat,” respectively. In such a case, the evaluation module 310 may generate a low CHRF score, due to missing character “e” in the translation output.

The evaluation module 310 may use the WER to measure a minimum number of edits (e.g., insertions, deletions, or substitutions) required for changing the translation output into the reference translation. By performing evaluation using the WER, the evaluation module 310 may evaluate the overall accuracy of the language translation at the word level. Based on the evaluation performed using the WER, the evaluation module 310 may generate the score value like a WER score. A high WER score may indicate many word-level edits (insertions, deletions, or substitutions) are required to change the translation output into the reference translation and suggest a high level of word-level errors and word-level mistakes (such as incorrect word choices). A low WER may indicate enhanced word-level accuracy. The low WER may also suggest that few word-level edits are required to change the translation output into the reference translation, implying respectable word-level accuracy in the translation output. For example, consider that the translation output and the reference translation include “The cat sleeps on the mat” and “The cat sat on the mat,” respectively. In such a case, the evaluation module 310 may generate the WER score as ⅙=0.1667, as an edit is required for 6 words to substitute “sleeps” with “sat” in the translation output.

The evaluation module 310 may use the MER to evaluate if each word in the translation output match exactly and in order with some words in the reference translation. Further, the evaluation module 310 may assign a penalty for each word in the translation output that does not match exactly and in order with some words in the reference translation. Therefore, with the MER, the evaluation module 310 may assess overall fluency and structure of the translation output. Further, the MER may not count insertions as errors. Therefore, even though if the translation output has extra/additional words, the evaluation module 310 may generate a high MER score. The high MER score may indicate many words in the translation output do not match exactly and in order with some word in the reference, issues with fluency and structure, and losing of important information in the translation output. A low MER score may signify the words in the translation output match exactly and in order with the reference translation. The low MER may also suggest that improved structural correctness and fluency and structure in the translation output. For example, consider that the translation output and the reference translation include “The cat sat beautifully on the large mat” and “The cat sat on the mat,” respectively. In such a case, the evaluation module 310 may generate a MER score of ‘0’, as all the words in the reference translation are present in the translation output.

The evaluation module 310 may use the WIL to measure a percentage of information lost in the translation output by identifying how much of meaning of the original data was lost in the translation output. Thereby, the evaluation module 310 may determine a semantic loss. Based on the evaluation performed using the WIL, the evaluation module 310 may generate the score value like a WIL score. A high WIL score may indicate that a high percentage of information was lost in the translation, suggesting important content was missed. A low WIL score may indicate that a high level of content preservation. Further, the low WIL may indicate that a small percentage of information was lost in the translation and suggest that the translation output did not omit or incorrectly translate important content from the reference translation.

The evaluation module 310 may use the WIP to measure an amount of information that was successfully preserved in the translation output by identifying how much of the original data's meaning was successfully conveyed in the translation output. Based on the evaluation performed using the WIP, the evaluation module 310 may generate the score value like a WIP score. A high WIP score may indicate that a high amount of information was successfully preserved in the translation output and suggests a content preservation. Further, the high WIP score may indicate that a large amount of information was successfully preserved in the translation output, implying that the translation managed to maintain the overall meaning and important details from the original data. A low WIP score may indicate issues with content preservation (e.g., failing to preserve the overall meaning or important details from the original data).

The evaluation module 310 may use the CER to perform the character analysis on the translation output. Based on the evaluation performed using the CER, the evaluation module 310 may generate the score value like a CER score. A high CER score may indicate that many character-level edits are required to change the translation output into the reference translation, indicating character-level errors. A low CER score may indicate high character-level accuracy (like spelling of individual words). The low CER may further indicate that few character-level edits are required to change the translation output into the reference output. The low CER may furthermore suggest high character-level accuracy in the translation output, with minimal misspellings or incorrect usage of special characters. For example, consider that the translation output and the reference translation include “Th cat sat beautifully on the large mat” and “The cat sat on the mat,” respectively. In such a case, the evaluation module 310 may generate a CER score of 1/9=0.0526 (1 edit for 19 characters), as all the words in the reference translation are present in the translation output.

The hLEPOR may be a “Harmonic mean of enhanced Length Penalty, Precision, n-gram Position difference Penalty and Recall.” The evaluation module 310 may use the hLEPOR to measure precision, recall, and the position difference penalty of n-grams between the translation output and the reference translations, which may provide a balanced evaluation of translation quality. Therefore, using the hLEPOR, the evaluation module 310 may capture both the correctness and fluency of the translation output. Further, based on the evaluation of the translation output with respect to the reference translation using the hLEPOR, the evaluation module 310 may generate the score value like a hLEPOR score. A high hLEPOR score may indicate that the translation output has a high balance of precision, recall, and correct word order. Further, the high hLEPOR score may imply a fluent and accurate translation with correct word positioning.

The evaluation module 310 may use the Multilingual BERT Sentence Transformer and Universal Sentence Encoder to convert sentences of the translation output and the reference translation into meaningful vector representations. From the meaningful vector representations, the evaluation module 310 may capture semantic meaning of the sentences. The semantic meaning may be further used to compute a cosine similarity score. The evaluation module 310 may further use the cosine similarity score to measure similarities between the sentences in the translation output.

The evaluation module 310 may use the BERT-word embeddings to convert sentences in the translation output and the reference translation into meaningful vector representations/BERT embeddings. The evaluation module 310 may further analyze the BERT embeddings to generate a BERT score. A high BERT score may indicate a high degree of overlap in BERT embeddings between the predicted and reference text. Further, with the BERT-word embeddings, the evaluation module 310 may calculate the precision, recall, and FI score (e.g., supplements the score value and is not a replacement). In addition, with the BERT word embeddings, the evaluation module 310 may perform the evaluation by considering semantic similarity of words and sentences, which may not be captured by the evaluation performed using the BLEU, the ROUGE, and/or the like.

The evaluation module 310 may use paraphrasing to generate a restatement of a meaning of a text or passage using other words in the translation output. The restatement may be generated to maintain the same meaning in the translation output as the original data while changing the wording and syntax. The evaluation may be performed using the paraphrasing for the aspects such as accuracy, precision, recall, and FI score. Further, based on evaluation performed using the paraphrasing, the evaluation module 310 may generate a paraphrasing score. A high paraphrasing score may indicate the paraphrasing is effective in generating paraphrases of the translation output that preserve the original meaning and identifying whether two texts of the translation output and the reference translation are paraphrases of each other.

The evaluation module 310 may use the textual entailment to determine whether a given piece of text (e.g., hypothesis) in the translation output is inferred from another text (e.g., premise) or not. The evaluation module 310 may also use the textual entailment to determine logical relationships between the sentences. Based on the evaluation performed using the textual entailment, the evaluation module 310 may generate a textual entailment score. A high textual entailment score may indicate effective evaluation of whether the hypothesis can be logically inferred from the premise. Such an evaluation may be performed for the aspects like accuracy, precision, recall, and the F1 score.

The evaluation module 310 may use a Bilingual Evaluation Understudy with Representations from Transformers (BLEURT) for evaluating the translation output with respect to the reference translation. In some examples, the BLEURT may be pre-trained language models and specifically trained for evaluation. The evaluation module 310 may use the BLEURT to compare a sentence in the translation output with a sentence in the reference translation by encoding the sentences into a high-dimensional space and then predicting a score based on the encoding. The evaluation module 310 may also use the BLEURT to capture complex linguistic phenomena that are often missed by other metrics. The BLEURT may be trained based on a large amount of user feedback data, which may help the BLEURT to align with user feedback.

The evaluation module 310 may use the synonym match score with the Bert-word embeddings for evaluation of the translation output with respect to the reference translation. For example, using the synonym match score with the Bert-word embeddings, the evaluation module 310 may derive synonym matches between the translation output and the reference translation.

In some examples, along with the scoring/numerical metrics and the semantic metrics, the evaluation module 310 may use boosting metrics for evaluating the translation output with respect to the reference translation or for boosting the score values generated for the numerical metrics. Examples of the boosting metrics may include a synonym booster, a polysemy and harmony booster, random bootstrapping scores, and/or the like.

The evaluation module 310 may use synonym booster to perform word to word comparison and n-gram comparison between the translation output and the reference translation. Also, the synonym booster may be used to boost the score values generated for the numerical metrics via a model, for example, multilingual hugging face model supporting multiple languages (e.g., 102 languages).

For synonym-based boosting, the synonym booster may use word-to-word, n-gram, and sentence level comparisons facilitated by a multilingual model, such as a Hugging Face model, which supports various languages. The synonym booster may be designed based on a custom formula determined by a cosine similarity threshold value. As the synonym booster may support word level, n-gram level, and sentence level comparisons, effectiveness of the synonym booster may be enhanced. Incorporation of methods such as addition, arithmetic mean, harmonic mean, and geometric mean may allow for a combination of different measures of similarity into a single numerical score. For example, the synonym booster may enhance the numerical score when synonyms are identified. Conversely, if the synonym booster finds lower similarity or distance metrics, the synonym booster may reduce the numerical score. To ensure consistency across different measures of similarity, which may have varying ranges, a normalization step may be applied at the end to adjust all scores to a same scale (e.g., from 0 to 1).

The evaluation module 310 may use the polysemy and homonymy booster for boosting the score values of the numerical metrics. In some examples, the polysemy and homonymy booster may include clustering and dimensionality reduction techniques such as, Density-Based Spatial Clustering of Applications with Noise (DBSCAN), Principal Component Analysis (PCA), and t-Distributed Stochastic Neighbor Embedding (t-SNE) and/or the like, which may support multiple languages (e.g., 102 languages).

In addition to handling polysemy and homonymy, the evaluation module 310 may also incorporate linguistic concepts such as hypernymy and hyponymy. Hypernymy may refer to a word with a broad meaning that forms a category into which words with more specific meanings may be classified. For example, “animal” is a hypernym for words like “dog”, “cat”, and “horse”. Conversely, hyponymy may refer to words with more specific meanings that fall under a general or superordinate term. For example, “rose”, “tulip”, and “daisy” are hyponyms of the hypernym “flower”. WordNet may be used to identify the hypernyms or hyponyms of words. If a word is identified as a hypernym or a hyponym of another according to the WordNet, a match count may be increased, enhancing effectiveness of the polysemy and homonymy booster booster.

Various linguistic challenges may also be addressed to enhance accuracy and effectiveness of natural language processing tasks. The evaluation module 310 may use WordNet to manage antonymy which refers to a relationship between words with opposite meanings. The WordNet may refer to a lexical database of English that groups words into sets of synonyms and records their semantic relations, including antonyms. The evaluation module 310 may use Word Sense Disambiguation (WSD) algorithms to handle polysemy which refers to capacity for a word or a phrase to have multiple meanings. Libraries such as Natural Language Toolkit (NLTK) in Python provide basic WSD algorithms to address the polysemy. The evaluation module 310 may use custom models trained on specific datasets with sentiment analysis models for handling challenges like euphemisms and sarcasm. Pretrained transformer models, such as those from John Snow, may be employed to detect nuances in communication, including sarcasm and various emotions. The pretrained transformer models help in identifying implicit sentiments, tones, or moods within a text, which are crucial for effective interpretation of human language. Such capabilities are vital for understanding complex linguistic phenomena such as irony, humor, and other forms of figurative language. These capabilities are especially important in applications like social media analysis and customer feedback interpretation, where understanding the underlying sentiment or tone can provide valuable insights.

Further libraries like NLTK and SpaCy, and a custom dictionary or training models on domain-specific data may be used by the evaluation module 310 to address collocations, idioms, jargon, and slang. The evaluation module 310 may use SpaCy for handling grammatical and structural differences. The evaluation module 310 may use contextual word embeddings from models like BERT or Embeddings from Language Models (ELMO) that assist in understanding context of words and sentences. The evaluation module 310 may manage orthographic distinctions and language overlaps through character-level analysis or subword-level models, with libraries like fastText. The evaluation module 310 may use dependency parsing, coreference resolution, paraphrase scoring, and Part-of-Speech (POS) tagging for maintaining semantic, lexical, syntactical, and linguistic integrity. Dependency parsing may be used to identify grammatical structures in sentences by establishing relationships between “head” words and their modifiers, which is crucial for understanding semantic relationships. Further, coreference resolution may be used to link pronouns or noun phrases that refer to a same entity within a text, addressing phenomena like anaphora and cataphora. Anaphora refers to a pronoun or noun phrase that refers to a previously mentioned word (e.g., “John said he would come”), while cataphora refers to a pronoun or noun phrase that anticipates a later reference (e.g., “When he arrived, John was grected by his friends”). Both the anaphora and cataphora may be essential for maintaining coherence in a text.

In an example, paraphrase scoring may be employed to measure similarity between two text segments, aiding in tasks such as text summarization, machine translation, and/or question-answering. Further, POS tagging may be employed to label each word in a sentence with its appropriate part of speech (e.g., noun, verb, adjective, or the like), providing foundational information for grammatical analysis. By integrating these techniques, an ability to understand and process natural language may be enhanced, improving semantic, syntactic, lexical, textual quality, and linguistic integrity.

The evaluation module 310 may use the random bootstrapping scores to estimate the sampling distribution on the translation output. The sampling distribution may be used to estimate standard errors, confidence interval range, and statistical significance in the translation output.

In some examples, the evaluation module 310 may also use metrics such as keyword comparison, n-gram comparison, Bag of Words (BOW) comparison, TF-IDF comparison, stemmer, lemmatization, Named Entity Recognition (NER) tags removal for evaluating the translation output with the reference translation.

Therefore, implementations of the present disclosure may use the effective and improvised metrics to evaluate the translation output with respect to the reference translation. As each metric may be having its own strengths, a more comprehensive evaluation may be performed. In addition, utilizing the variety of metrics (rather than using a single metric) may result into the more robust evaluation and provide a holistic view of quality of the language translation. As would be understood, along with the metrics and the associated score values, other factors such as quality of training dataset, a diversity of the training dataset, and how well the LLM 104 is generalized to real-world examples may also be considered for the evaluation.

Upon evaluating the translation output of each of the chunks, the evaluation module 310 may generate a SAFE score value for the translation output of each of the chunks. The SAFE score value may represent an overall assessment of the translation output based on the evaluation performed using a combination of the multiple metrics (e.g., the numerical metrics, the semantic metrics, the boosting metrics, and/or the like) described herein.

The SAFE score value for the translation output may be generated based on the score values generated for the numerical metrics corresponding to the respective translation output, and/or results of the evaluation performed using the semantic metrics and the boosting metrics. In some examples, if the score values are normalized score values, the SAFE score value may be generated by aggregating the score values. In some other examples, if the score values are not normalized, the SAFE score value may be generated by normalizing the score values using a linear regression sigmoid function and using the normalized score values.

The evaluation module 310 may further compare the SAFE score value with a predetermined threshold condition. If the SAFE score value meets the predetermined threshold condition, the evaluation module 310 may identify that the LLM 104 is performing efficiently and cause the translation output to be transmitted or presented to the user through the application manager 114 in response to the received request/prompt. If the SAFE score value does not meet the predetermined threshold condition, the evaluation module 310 may reject the translation output and identify that the LLM 104 is inefficient for the language translation. Subsequently, the LLM 104 may be retrained or fine-tuned by the model trainer 204 or the model tuner 202 for subsequent generation of a new translation output.

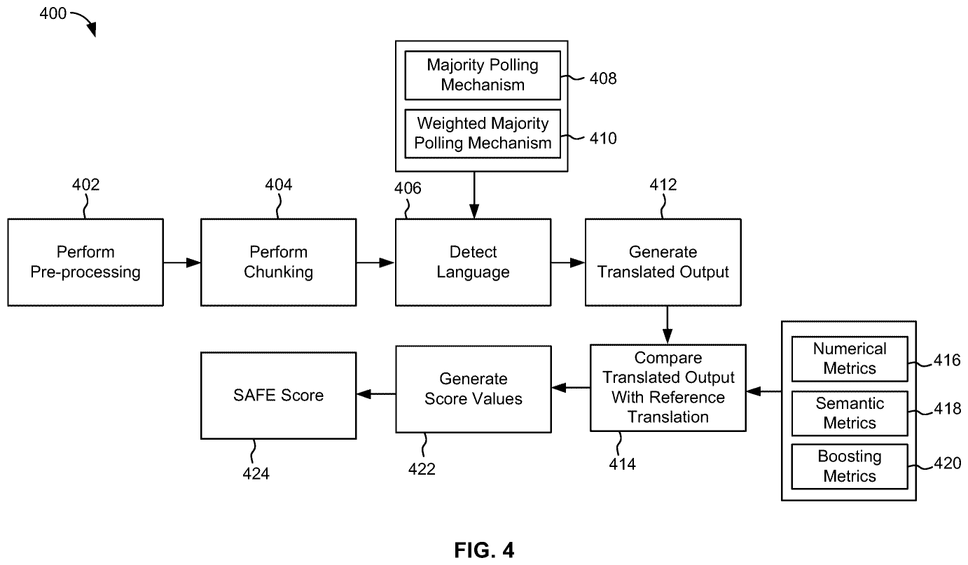

FIG. 4 depicts an example process flow 400 of language detection and evaluation of language translation using the RAIOPS integrated LLMOPS metrics, in accordance with implementations of the present disclosure. The process flow 400 may be executed by the language detection and translation system 100 (depicted in FIG. 1) using the Gen AI integration and evaluation engine 112 (depicted in FIGS. 1-3).

The language detection and translation system 100 pre-processes 402 the data received in the request for the language translation. The pre-processing of the data may include removing the noise from the data, while retaining the stop words in the data. Upon pre-processing the data, the language detection and translation system 100 performs 404 chunking to split the data into the multiple chunks. Each chunk may include the subset of the data.

The language detection and translation system 100 further detects 406 the language of each chunk. In some examples, the language of each chunk may be detected using the majority poling mechanism 408 and the weighted majority polling mechanism 410, which are described in detail along with the language detection module 306 in FIG. 3, and therefore repeated description is omitted herein for sake of brevity. In some other examples, the language of each chunk may be detected using the language detection libraries such as, langid, fasttext, john snow, spark NLP language detectors, and/or the like. Using such techniques, the language detection and translation system 100 may detect multiple languages in a chunk, where the chunk is a sentence of sentences and/or a portion of the sentence.

Upon detecting the language of each chunk, the language detection and translation system 100 generates 412 the translation output for each chunk. The language detection and translation system 100 uses the LLM 104 for generating the translation output for each chunk based on techniques, for example, T5 translation, Marian translation, and/or the like. The translation output for a chunk may be generated by translating the subset of the data in the respective chunk to the one or more preferred target translation languages. For example, the subset of the data detected in English language may be translated to the preferred target translation languages such as, German, French, Romanian, and/or the like.

The language detection and translation system 100 further compares 414 the translation output of each chunk with the reference translation. The translation output of each chunk may be compared with the reference translation using the combination of metrics such as, the numerical metrics 416, the semantic metrics 418, and the boosting metrics 420. The metrics 416-420 are already described in detail along with the evaluation module 310 in FIG. 3, and therefore repeated description is omitted herein for sake of brevity.

Based on the comparison of the translation output of each chunk with the reference translation using the combination of metrics, the language detection and translation system 100 generates 422 the score values for the numerical metrics 416 corresponding to the translation output of each chunk. Depending on the score values of the numerical metrics 416 corresponding to the translation output of each chunk, the language detection and translation system 100 generates 424 the SAFE score value for the translation output of each chunk. The SAFE score value may be used to evaluate accuracy, performance, quality, and/or the like, of the respective translation output.

By way of an example, consider a scenario where the language detection and translation system 100 receives a request from a user for translating data in the request to a preferred target language, for example, French. The data may include sentences “The weather is beautiful today. It is a great day to go for a walk. The sun is shining, and the sky is clear.” For high quality translation, the language detection and translation system 100 splits the data into three chunks such as “The weather is beautiful today,” “It is a great day to go for a walk,” and “The sun is shining, and the sky is clear.” Each chunk represents a sentence from the data and is processed separately to streamline the language translation.

By way of another example, consider a complex scenario where the language detection and translation system 100 receives a request to translate data that includes a combination of various minority and majority languages. The data may include sentences “I find this awesome [symbol] [symbol] but there are plots. Es war ein wundervoller alter Glaube bei den Griechen, daß jedem neugeborenen Menschenwesen ein Stern am Himmel angezündet werde, der bei seinem Tod erlösche. Die Helligkeit und Gröβe des Gestirnes mochten der Bedeutung der Persönlichkeit entsprechen: so rühmte man vom König Mithradates, der drei Kriege gegen Rom geführt hat, bei seiner Geburt sei ein Komet erschienen, dessen Schweif den vierten Teil des Himmels überzog und siebzig Tage sichtbar blieb. [symbol] Paris symbolise la culture française. En 2017, elle est classée comme étant la ville la plus élégante au monde.” In such a scenerio, the language detection and translation system 100 may separate the sentences to ensure detection of all languages, including the minority languages. The language detection and translation system 100 may split the data into different chunks such as “I find this awesome”, “ [symbol] ”, “but there are plots.”, “Es war ein wundervoller alter Glaube bei den Griechen”, “daß jedem neugeborenen Menschen . . . ”, etc. Each of these chunks may then be processed further for language detection and translation. To address potential issues with overlapping words from different languages that may lead to inaccuracies, the detection and translation system 100 may further divide the non-Latin scripts into smaller chunks. In an example, after experimentation, a chunk size of “10 words” has been selected to enhance the accuracy the language detection and translation system 100 and ensure all relevant languages in the data are identified.

The language detection and translation system 100 detects a language of each chunk. In this case, since all the chunks are in English, the language detection and translation system 100 may confirm the language of each chunk consistently, while ensuring that the translation process starts with the correct language identification for each chunk. Furthermore, the language detection and translation system 100 may convert each chunk into French using the LLM 104. For example, the English chunk “The weather is beautiful today” may be translated as “Le temps est magnifique aujourd'hui.” Each chunk may be translated independently, thereby generating the translation output for each chunk.

The language detection and translation system 100 further initiates an evaluation process. In some examples, for the evaluation process, the translated output of each chunk may be converted into the language supported by the reference translation (e.g., French to English) and accordingly compare the translation output with respect to the reference translation using the combination of metrics. Based on the evaluation, the language detection and translation system 100 generates score values for the translation output of each chunk. For instance, a precision is evaluated by determining the proportion of words in the translation output that match those in the reference translation. If the translated output matches the reference output, the precision may be considered as high. Further, the language detection and translation system 100 generates the SAFE score for the translation output of each chunk based on the respective score values. For instance, the SAFE score is computed for the translation output of the chunk as “85” and the predetermined threshold is set at 80. Since the SAFE score surpasses the predetermined threshold, the translation output may be deemed high-quality. Consequently, the translated output may be transmitted or presented to the user, ensuring that only the translation outputs meeting the required standards are delivered.

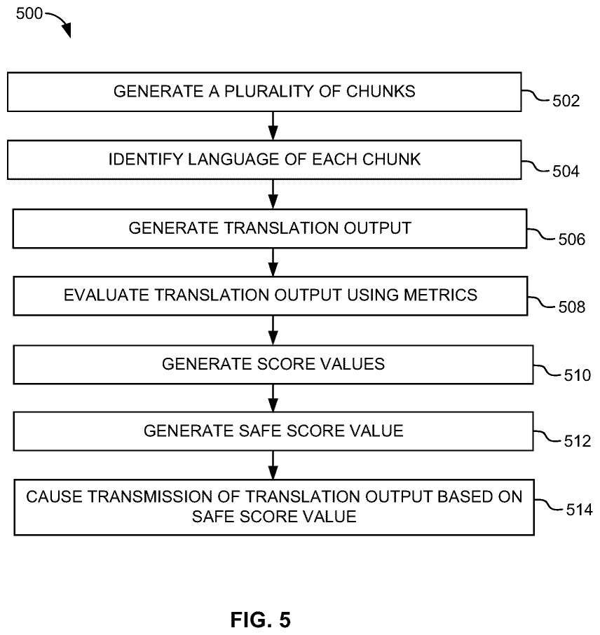

FIG. 5 is a flow diagram that presents an example computer-implemented method 500 for improving a language detection task and a language translation task of a LLM 104, in accordance with implementations of the present disclosure. The method may be performed by executing the various components 302-310 of Gen AI integration and evaluation engine 112 (depicted in FIG. 3) on the processor 108 of the language detection and translation system 100 (depicted in FIG. 1).

The method includes generating 502, in response to receiving data associated with the prompt/request, a plurality of chunks. Each chunk of the plurality of chunks may include a subset of the data. The subset of the data may include data associated with at least one sentence or a sequence of a preconfigured number of words (e.g., a portion of a sentence). In an example, the data may be split into a plurality of sentences based upon a type of alphabets identified in the data. By way of an example, the data associated with the prompt may be “The weather is beautiful today. It is a great day to go for a walk. The sun is shining, and the sky is clear.” Further, three chunks “The weather is beautiful today.”, “It is a great day to go for a walk.”, and “The sun is shining, and the sky is clear.” may be generated by splitting the data associated with the prompt. In this case, each chunk includes one sentence. If a specific number of words are required in a chunk, the sentences may be split further or joined together. Furthermore, in an example, irrelevant information data may be identified and removed from each chunk of the plurality of chunks.

The method includes identifying 504 a language of each chunk. In some examples, the language of each chunk may be identified using a plurality of language detection libraries. In some other examples, the language may be determined using at least one of a majority polling mechanism and a weighted majority polling mechanism. Identifying the language of each chunk is described in detail in conjunction with FIG. 3, and therefore repeated description is omitted herein for sake of brevity.

The method includes generating 506 a translation output using the LLM 104 (depicted in FIG. 1), in a preferred target translation language. Further, the method includes evaluating 508 the translation output using a plurality of metrics. Each metric of the plurality of metrics may evaluate the translation output for one or more translation quality aspects. The one or more translation quality aspects may include a precision, a recall, a semantic quality of the translation output, a synonymy, a paraphrasing, a word order, an under-translation, an over-translation, a number of insertions required, a number of deletes required, a number of substitutions required, a number of shifts required, information preserved or lost in the translation output, a fluency of the translation output, and a lexical quality of the translation output. The plurality of metrics may include the numerical metrics, the semantic metrics, and the boosting metrics, which are described in detail in conjunction with FIG. 3, and therefore repeated description is omitted for sake of brevity.

The method includes generating 510 a score value for each numerical metric of the plurality of metrics. The method includes generating 512 a SAFE score or a SAFE score value. The SAFE score (or the SAFE score value) is generated 512 based upon the score value for each numerical metric of the plurality of metrics. Once individual score values for each numerical metric have been generated, the score values may be combined to generate a composite score referred to as the SAFE score. Such a combination/aggregation of the individual scores may involve integrating the plurality of metrics into a single, unified measure of translation quality. The SAFE score may represent an overall assessment of the translation output based on the weighted or combined metrics, providing a more comprehensive evaluation than any single metric alone.

The method includes causing 514 the translation output to be transmitted or presented, upon determining that the SAFE score value meets a predetermined threshold condition. After generating the SAFE score, the method evaluates whether the SAFE score meets the predetermined threshold condition. The predetermined threshold condition may be a predefined benchmark or cutoff value that determines acceptability of quality of the translation output. If the SAFE score meets or exceeds the predetermined threshold condition, the translation output is considered of sufficient high-quality and is then transmitted or presented to an end-user or relevant stakeholders. Therefore, only the translation output meeting the quality standards are delivered, while enhancing reliability and usability of the translation output.

Implementations of the present disclosure provide technical solutions to multiple technical problems that arise in the context of language detection and evaluation of language translation. Implementations of the present disclosure ensure:

Improvement in translation accuracy: By addressing common issues such as synonym detection and semantic preservation, the proposed methodology may enhance the quality of translated output, making them more accurate and contextually appropriate.

Efficiency in language processing tasks: The proposed methodology may streamline language detection and processing by reducing time and computational resources required for analyzing multilingual data.

Support for lesser-resourced languages: The proposed methodology may use broad language coverage, which may further support the translation of lesser-resourced languages, which are often underserved by mainstream models.

Increased user satisfaction: The proposed methodology may present only the translation output determined to be of high quality, which may lead to increasing satisfaction and engagement among the users.

Accuracy in legal and healthcare translations: Improved translation accuracy may benefit high-stakes fields like legal and healthcare services, while reducing risks associated with translation errors and ensuring reliable communication.

Implementations of the present disclosure further provide the following advantages:

Resolution of ambiguity in language detection: The proposed methodology may address challenges in determining the language of the data in the prompt amidst multiple languages or ambiguous cues through advanced language detection frameworks, which may ensure more accurate language identification.

Consistency in translation quality: By using the metrics across a wide range of languages and text types, the proposed methodology may ensure consistent evaluation of translation quality, accommodating diverse linguistic contexts and improving reliability.

Enhanced translation evaluation: The proposed methodology may employ comprehensive evaluation methods that go beyond simple accuracy, incorporating semantic and syntactic nuances to better quantify and assess translation quality.

Improved handling of synonyms: The use of techniques such as BERT for synonym detection enhances recognition and accurate translation of synonyms, addressing common issues in translation and improving the naturalness and precision of translated texts.

Scalability for multilingual translation: The proposed methodology may provide a scalable solution capable of efficiently handling translations for numerous languages without compromising translation quality, making it suitable for diverse and extensive applications.

Reduction of semantic loss: By integrating semantic methods with vector space models, the loss of semantic meaning may be minimized during translation, preserving intent of the original content and context more effectively.

Streamlined evaluation of metric customization: The proposed methodology may simplify adaptation and customization of the metrics, allowing for more precise and context-specific assessment of translation tasks, reducing complexity, and improving case of use.

Noise reduction in language data: The proposed methodology may incorporate a pre-processing step designed to remove irrelevant or extraneous information that may impede accurate language detection and translation. While stop words are preserved for their value in language analysis, the focus is on breaking down the content into manageable sentences or chunks, improving overall data quality.

Enhanced language detection accuracy: The proposed methodology may employ an ensemble or majority voting mechanism that leverages multiple language detection libraries. Therefore, the accuracy of identifying the language of a given text, even in the presence of ambiguous language cues, is improved.

Refined weighted post-processing: Inclusion of advanced weighting mechanisms in the post-processing stage further enhances the accuracy of language detection outputs, leading to more reliable and precise results.

Comprehensive translation quality evaluation: The proposed methodology may use a variety of metrics such as BLEU, GLEU, METEOR, and Recall-Oriented Understudy for Gisting Evaluation (ROUGE) to assess translation quality. This multi-metric approach provides a thorough evaluation of translated text, with random bootstrapping techniques applied for handling larger datasets, ensuring robust and detailed quality assessment.

Improved synonym detection: By utilizing a custom metric and BERT-based synonym matcher, the proposed methodology may effectively identify synonyms and boost evaluation scores when synonym matches occur, enhancing the precision of translation quality assessment.

Effective handling of multilingual content: The proposed methodology may offer mechanisms for managing multilingual content, enabling accurate translations across a wide range of languages, and enhancing semantic understanding.

Advanced semantic translation evaluation: By leveraging NLP models like BERT and multilingual sentence encoders, semantic similarities in high-dimensional vector spaces may be evaluated, and thereby ensuring translations preserve the original meaning and context as closely as possible.

Reduction in translation errors: Translation edit metrics are used to minimize various forms of translation errors, including character error rate, word error rate, and match error rate, leading to more accurate and error-free translations.

Scoring based on synonym matching: The scoring as described in the present disclosure boosts evaluation scores when synonyms are detected, improving accuracy of translation quality assessment by accounting for synonymy.

Enhanced cost-efficiency in translation: The automation and improved accuracy in language detection and translation processes may reduce the need for human intervention, potentially lowering translation costs and increasing efficiency.

Granular language detection: The proposed methodology may enhance fine-grained language detection capabilities for accurately identifying languages at the level of individual sentences or phrases within documents containing multiple languages.

Speed and scalability in language detection: By utilizing fast and efficient tools like fasttext, performance and scalability of language detection processes is enhanced, enabling efficient handling of large datasets.

Integration of diverse language detection models: By combining various language detection models and approaches (e.g., langid, fasttext, Spark NLP) results of language detection may be corroborated and overall confidence in the detected language may be increased, providing a more robust framework for the language detection.

Complex multilingual text processing: The proposed methodology may address complexities of processing multilingual texts by accurately splitting texts into sentences and detecting language of each sentence, improving overall translation accuracy.

Advanced NLP capabilities for diverse languages: By utilizing the robust NLP capabilities of John Snow Labs' Spark NLP, the proposed methodology may support a wide range of languages and NLP tasks, offering comprehensive and effective language processing.

Visualization of translation topics: Tools like Gensim and pyLDAvis are used to visualize translation topics, adding interpretability to the translation process, and providing insights into the thematic content of translations.

Support from LLMs and cost benefits: The proposed methodology may efficiently handle language detection tasks and may avoid submitting documents in English to LLMs for translation, reducing associated costs and enhancing cost efficiency.

SAFE score calculation: A SAFE score value is calculated for the numerical metrics, which may be inversely proportional to the score values associated with the numerical metrics. High score values associated with the numerical metrics may result in low SAFE scores, and vice versa. This calculation provides a normalized measure of translation quality.

Normalization and score adjustment: For non-normalized scores, a linear regression sigmoid function is applied to normalize the metric scores before calculating the SAFE score, ensuring consistent evaluation.

Boosting synonym scores: By using models from Hugging Face, the proposed methodology may boost scores for synonyms detected in translations, improving evaluation accuracy, and supporting various languages.

Dimensionality reduction techniques: The techniques such as DBSCAN, PCA and t-SNE are used to enhance numerical scores for polysemy and homonymy, supporting various languages and refining translation evaluation.

Bootstrap sampling: The bootstrap sampling may be used to estimate the sampling distribution of the translation output by resampling with replacement, allowing for the estimation of standard errors, confidence intervals, and statistical significance from smaller sample sizes.

Further, implementations of the present disclosure use the multiple metrics for evaluating translation performance of the LLMs, which provides the following advantages:

Comprehensive evaluation: The metrics may offer a holistic assessment of translation quality by examining different aspects, ensuring a thorough evaluation.

Detailed insight into strengths and weaknesses: Each metric captures distinct features of translation performance, helping identify specific areas where the LLM excels or needs improvement. For example, high BLEU scores may indicate good exact match accuracy, while low METEOR scores may reveal issues with synonym handling or word order.

N-gram accuracy: The metrics like BLEU and ROUGE may provide insights into different facets of n-gram accuracy. A high BLEU score with a low ROUGE score may suggest precise n-gram matching but potential gaps in content coverage.

Focus on different aspects: BLEU may be effective for evaluating exact word matches, while ROUGE may assess overall content coverage and completeness. The use of both the BLEU and ROUGE metrics may ensure that translation outputs are evaluated for both accuracy and coverage.

Content coverage versus length penalty: High ROUGE scores paired with low hLEPOR scores may indicate that the translation output captures a lot of content from the reference translation.

Synonym handling versus information capture: A high METEOR score but low ROUGE score may suggest proficiency in handling synonyms and paraphrasing.

Character precision versus length penalty: Excel in metrics like hLEPOR but underperforming in the CHR-F may show strength in managing length penalties while possibly struggling with character-level precision and recall.

Matching individual words vs. multiple valid translations: High BLEU1-4 scores with low GLEU scores may indicate good performance on specific word matches but challenges in handling multiple valid translations effectively.

Character matching versus word-level accuracy: High Character F-score (CHR-F) scores with low word_error_rate imply strong character-level matching but potential issues with overall word-level accuracy.

Semantic similarity versus content capture: A high METEOR score combined with a low ROUGE score may point to effective semantic similarity and word order handling.

Handling multiple correct answers: Scoring well on GLEU but poorly on BLEU1-4 may suggest effectiveness in scenarios with multiple valid translations, but less precision in matching individual words and phrases.

Word-level accuracy versus. word matching: High word_error_rate with low match_error_rate may indicate that while a large proportion of words are matched, there may be issues with overall word-level accuracy.

Enhanced robustness: The use of a range of metrics reduces reliance on any biases of single metric or weaknesses, providing a more robust and balanced evaluation of translation quality.

In addition, implementations of the present disclosure further use random bootstrap sampling method for the data including larger datasets/points, which may boost the score values and/or the SAFE score value generated based on the evaluation. Further, the random bootstrap sampling method may be used for:

Deriving confidence Intervals: The bootstrapping sampling method may allow for the estimation of confidence intervals for the metrics. By resampling the evaluation set many times and computing the metric for each sample, a distribution of scores may be obtained. The distribution of scores may then be used to estimate the confidence interval of the metric, providing a measure of the metric's robustness and reliability.

Variance Reduction: The bootstrapping sampling method may aid in reducing the variance of the metrics. By generating many resamples of the evaluation set, each with slightly different compositions, the overall variance of the metrics can be reduced. Due to which, the metric may become more stable and less sensitive to changes in the evaluation set.

Overcoming Data Limitations: If the size of the evaluation set is small, the metrics may not be reliable. In such a case, the bootstrapping sampling method may help to overcome such a limitation by generating many different evaluation sets from the original data, allowing for a more robust estimation of the metric.

Statistical Significance: The bootstrapping sampling method may also be used to test the statistical significance of the difference between two metrics. By resampling the evaluation set and computing the difference between the two metric scores for each sample, a distribution of differences may be obtained. The distribution of differences may then be used to test whether the observed difference in the metrics is statistically significant. For example, the distribution of differences may help in determining whether the difference in scores is due to random chance or represents a real difference in performance.

Robustness to Outliers: The bootstrapping sampling method may also improve the robustness of the metrics to outliers. Since the bootstrapping sampling method may involve sampling with replacement, it may help in mitigating the effect of outliers by reducing their likelihood of being included in each resample.

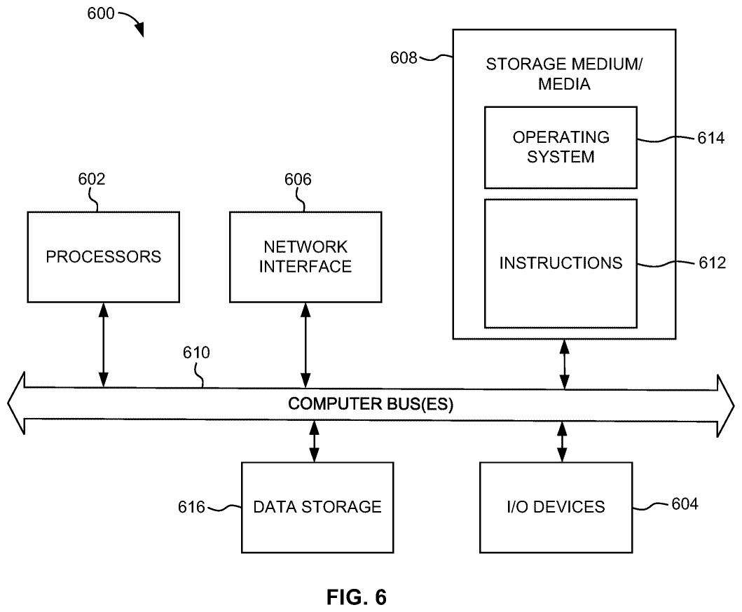

FIG. 6 illustrates a computer system 600 that may be used to implement the language detection and translation system 100. More particularly, computing machines such as desktops, laptops, smartphones, tablets, and wearables which may be used for language detection and evaluation of language translation. The computer system 600 may include additional components not shown and that some of the process components described may be removed and/or modified. In another example, a computer system 600 may be deployed on external-cloud platforms such as cloud, internal corporate cloud computing clusters, organizational computing resources, and/or the like.

The computer system 600 includes processor(s) 602, such as a central processing unit, Application Specific Integrated Circuit (ASIC) or another type of processing circuit, input/output devices (I/O) 604, such as a display, mouse keyboard, etc., a network interface 606, such as a Local Area Network (LAN), a wireless 802.11x LAN, a 3G or 4G mobile Wide Area Network (WAN) or a WiMax WAN, and a computer-readable dtorage medium/media 608. Each of these components may be operatively coupled to one or more computer bus(es) 610. The computer-readable storage medium/media 608 may be any suitable medium that participates in providing instructions to the processor(s) 602 for execution. For example, the computer-readable storage medium/media 608 may be non-transitory or non-volatile medium, such as a magnetic disk or solid-state non-volatile memory or volatile medium such as RAM. The instructions or modules stored on the computer-readable storage medium/media 608 may include machine-readable instructions 612 executed by the processor(s) 602 that cause the processor(s) 602 to perform the methods and functions of the language detection and translation system 100.

The language detection and translation system 100 may be implemented as software stored on a non-transitory processor-readable medium and executed by the processors 602. For example, the computer-readable storage medium/media 608 may store an operating system 614, such as MAC OS, MS WINDOWS, UNIX, or LINUX, and code for the language detection and translation system 100. The operating system 614 may be multi-user, multiprocessing, multitasking, multithreading, real-time, and the like. For example, during runtime, the operating system 614 is running and the code for the language detection and translation system 100 is executed by the processor(s) 602.

The computer system 600 may include a data storage 616, which may include non-volatile data storage. The data storage 616 stores any data used or generated by the language detection and translation system 100.

The network interface 606 connects the computer system 600 to internal systems for example, via a LAN. Also, the network interface 606 may connect the computer system 600 to the Internet. For example, the computer system 600 may connect to web browsers and other external applications and systems via the network interface 606.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for improving a language detection task and a language translation task of a Large Language model (LLM) comprising:
generating, by one or more processors in response to receiving data associated with a prompt, a plurality of chunks, each chunk of the plurality of chunks includes a subset of the data;
identifying, by the one or more processors, a language, of each chunk, using a plurality of language detection libraries;
generating, by the one or more processors using the LLM, a translation output in a preferred target translation language;
evaluating, by the one or more processors, the translation output using a plurality of metrics, each metric of the plurality of metrics evaluates the translation output for one or more translation quality aspects;
generating, by the one or more processors, a score value for each numerical metric of the plurality of metrics;
generating, by the one or more processors based upon the score value for each numerical metric of the plurality of metrics, a SAFE score value; and
causing, by the one or more processors based upon the SAFE score value that meets a predetermined threshold condition, the translation output to be transmitted or presented.

2. The computer-implemented method of claim 1, wherein the subset of the data includes data associated with at least one sentence or a sequence of a preconfigured number of words.

3. The computer-implemented method of claim 2, further comprising splitting the data into a plurality of sentences based upon a type of alphabets identified in the data.

4. The computer-implemented method of claim 1, further comprising identifying and removing irrelevant information data from each chunk of the plurality of chunks.

5. The computer-implemented method of claim 1, wherein the identifying comprises determining the language using at least one of a majority polling mechanism and a weighted majority polling mechanism.

6. The computer-implemented method of claim 1, wherein the evaluating further comprises evaluating the translation output using a bootstrap resampling method for selecting evaluation data from the translation output.

7. The computer-implemented method of claim 1, wherein the one or more translation quality aspects comprises a precision, a recall, a semantic quality of the translation output, a synonymy, a paraphrasing, a word order, an under-translation, an over-translation, a number of insertions required, a number of deletes required, a number of substitutions required, a number of shifts required, information preserved or lost in the translation output, a fluency of the translation output, and a lexical quality of the translation output.

8. A system for improving a language detection task and a language translation task of a Large Language Model (LLM), the system comprising:
at least one memory storing machine-executable instructions; and
at least one processor communicatively coupled with the at least one memory, wherein the at least one processor is configured to execute the machine-executable instructions to perform operations comprising:
generating, in response to receiving data associated with a prompt, a plurality of chunks, each chunk of the plurality of chunks includes a subset of the data;
identifying a language, of each chunk, using a plurality of language detection libraries;
generating, using the LLM, a translation output in a preferred target translation language;
evaluating the translation output using a plurality of metrics, each metric of the plurality of metrics evaluates the translation output for one or more translation quality aspects;
generating a score value for each numerical metric of the plurality of metrics;
generating, based upon the score value for each numerical metric of the plurality of metrics, a SAFE score value; and
causing, based upon the SAFE score value that meets a predetermined threshold condition, the translation output to be transmitted or presented.

9. The system of claim 8, wherein the subset of the data includes data associated with at least one sentence or a sequence of a preconfigured number of words.

10. The system of claim 9, wherein the operations further comprise splitting the data into a plurality of sentences based upon a type of alphabets identified in the data.

11. The system of claim 8, wherein the operations further comprise identifying and removing irrelevant information data from each chunk of the plurality of chunks.

12. The system of claim 8, wherein the identifying comprises determining the language using at least one of a majority polling mechanism and a weighted majority polling mechanism.

13. The system of claim 8, wherein the evaluating further comprises evaluating the translation output using a bootstrap resampling method for selecting evaluation data from the translation output.

14. The system of claim 8, wherein the one or more translation quality aspects comprises a precision, a recall, a semantic quality of the translation output, a synonymy, a paraphrasing, a word order, an under-translation, an over-translation, a number of insertions required, a number of deletes required, a number of substitutions required, a number of shifts required, information preserved or lost in the translation output, a fluency of the translation output, and a lexical quality of the translation output.

15. A non-transitory computer-readable media comprising instructions stored thereon for improving a language detection task and a language translation task of a Large Language Model (LLM), wherein the instructions, when executed by at least one processor of a computing device, cause the computing device to perform operations comprising:
generating, in response to receiving data associated with a prompt, a plurality of chunks, each chunk of the plurality of chunks includes a subset of the data;
identifying a language, of each chunk, using a plurality of language detection libraries;
generating, using the LLM, a translation output in a preferred target translation language;
evaluating the translation output using a plurality of metrics, each metric of the plurality of metrics evaluates the translation output for one or more translation quality aspects;
generating a score value for each numerical metric of the plurality of metrics;
generating, based upon the score value for each numerical metric of the plurality of metrics, a SAFE score value; and
causing, based upon the SAFE score value that meets a predetermined threshold condition, the translation output to be transmitted or presented.

16. The non-transitory computer-readable media of claim 15, wherein the subset of the data includes data associated with at least one sentence or a sequence of a preconfigured number of words, and wherein the operations further comprise splitting the data into a plurality of sentences based upon a type of alphabets identified in the data.

17. The non-transitory computer-readable media of claim 15, wherein the operations further comprise identifying and removing irrelevant information data from each chunk of the plurality of chunks.

18. The non-transitory computer-readable media of claim 15, wherein the identifying comprises determining the language using at least one of a majority polling mechanism and a weighted majority polling mechanism.

19. The non-transitory computer-readable media of claim 15, wherein the evaluating further comprises evaluating the translation output using a bootstrap resampling method for selecting evaluation data from the translation output.

20. The non-transitory computer-readable media of claim 15, wherein the one or more translation quality aspects comprises a precision, a recall, a semantic quality of the translation output, a synonymy, a paraphrasing, a word order, an under-translation, an over-translation, a number of insertions required, a number of deletes required, a number of substitutions required, a number of shifts required, information preserved or lost in the translation output, a fluency of the translation output, and a lexical quality of the translation output.
